(19) United States
(12) Patent Application Publication
(10) Pub. No.: US 2017/0371783 A1
(43) Pub. Date: Dec. 28, 2017

(54) SELF-AWARE, PEER-TO-PEER CACHE TRANSFERS BETWEEN LOCAL, SHARED CACHE MEMORIES IN A MULTI-PROCESSOR SYSTEM

(71) Applicant: QUALCOMM Incorporated, San Diego, CA (US)

(72) Inventors: Hien Minh Le, Cedar Park, TX (US); Thuong Quang Truong, Austin, TX (US); Eric Francis Robinson, Raleigh, NC (US); Brad Herold, Austin, TX (US); Robert Bell, JR., Raleigh, NC (US)

(21) Appl. No.: 15/191,686

(22) Filed: Jun. 24, 2016

(51) Int. Cl. G06F 12/084; G06F 12/0842

(52) U.S. Cl. CPC G06F 12/084; G06F 12/0842; G06F 2212/1024

(57) ABSTRACT

Self-aware, peer-to-peer cache transfers between local, shared cache memories in a multi-processor system is disclosed. A shared cache memory system is provided comprising local shared cache memories accessible by an associated central processing unit (CPU) and other CPUs in a peer-to-peer manner. When a CPU desires to request a cache transfer (e.g., in response to a cache eviction), the CPU acting as a master CPU issues a cache transfer request. In response, target CPUs issue snoop responses indicating their willingness to accept the cache transfer. The target CPUs also use the snoop responses to be self-aware of the willingness of other target CPUs to accept the cache transfer. The target CPUs willing to accept the cache transfer use a predefined target CPU selection scheme to determine its acceptance of the cache transfer. This can avoid a CPU making multiple requests to find a target CPU for a cache transfer.

### BACKGROUND

### I. Field of the Disclosure

The technology of the disclosure relates generally to a multi-processor system employing multiple central processing units (CPUs) (i.e., processors), and more particularly to a multi-processor system having a shared memory system utilizing a multi-level memory hierarchy accessible to the CPUs.

### II. Background

Microprocessors perform computational tasks in a wide variety of applications. A conventional microprocessor includes one or more central processing units (CPUs). Multiple (multi)-processor systems that employ multiple CPUs, such as dual processors or quad processors for example, provide faster throughput execution of instructions and operations. The CPU(s) execute software instructions that instruct a processor to fetch data from a location in memory, perform one or more processor operations using the fetched data, and generate a stored result in memory. The result may then be stored in memory. As examples, this memory can be a cache local to the CPU, a shared local cache among CPUs in a CPU block, a shared cache among multiple CPU blocks, or main memory of the microprocessor.

Multi-processor systems are conventionally designed with a shared memory system utilizing a multi-level memory hierarchy. For example, FIG. 1 illustrates an example of a multi-processor system 100 that includes multiple CPUs 102(0)-102(N) and a hierarchical memory system 104. As part of the hierarchical memory system 104, each CPU 102(0)-102(N) includes a respective local, private cache memory 106(0)-106(N), which may be Level 2 (L2) cache memory for example. The local, private cache memory 106(0)-106(N) in each CPU 102(0)-102(N) is configured to store and provide access to local data. However, if a data read operation to a local, private cache memory 106(0)-106(N) results in a cache miss, the requesting CPU 102(0)-102(N) provides the data read operation to a next level cache memory, which in this example is a shared cache memory 108. The shared cache memory 108 may be a Level 3 (L3) cache memory as an example. An internal system bus 110, which may be a coherent bus, is provided that allows each of the CPUs 102(0)-102(N) to access the shared cache memory 108 as well as other shared resources. Other shared resources that can be accessed by the CPUs 102(0)-102(N) through the internal system bus 110 can include a memory controller 112 for accessing a system memory 114, peripherals 116, and a direct memory access (DMA) controller 118.

With continuing reference to FIG. 1, the local, private cache memories 106(0)-106(N) in the hierarchical memory system 104 of the multi-processor system 100 in FIG. 1 allow the respective CPUs 102(0)-102(N) to access data in a closer memory with minimal bus traffic over the internal system bus 110. This reduces access latency as compared to accesses to the shared cache memory 108. However, the shared cache memory 108 may be better utilized in terms of capacity, because each of the CPUs 102(0)-102(N) can access the shared cache memory 108 for storage of data. For example, cache line evictions from the local, private cache memories 106(0)-106(N) may be evicted back to the shared cache memory 108 over the internal system bus 110. If a data read operation to the shared cache memory 108 results in a cache miss, the data read operation is provided to the memory controller 112 to access the system memory 114. Cache line evictions from the shared cache memory 108 are evicted back to the system memory 114 through the memory controller 112.

To maintain the benefit of lower memory access latency in a multi-processor system, like the multi-processor system 100 shown in FIG. 1 for example, but to also provide for improved cache memory capacity utilization, CPUs in a multi-processor system could be redesigned to each additionally include a local shared cache memory. In this regard, if a cache miss occurred to a local, private cache memory in response to a data read operation, the CPU could access its local shared cache memory first to avoid communicating the data read operation over an internal system bus for lower latency. However, local shared cache memories provided in the CPUs still provide for increased cache capacity utilization, because the local shared cache memories in the CPUs are accessible to the other CPUs in the multi-processor system over the internal system bus. But, if a cache line eviction were to occur from a local, private cache memory in a CPU to a local shared cache memory in another target CPU over the internal system bus, it is not known if the target CPU has spare capacity in its local shared cache memory to store the evicted cache data. Thus, the eviction of cache data from a CPU may have to be evicted to a system memory, resulting in additional latency over evictions to a non-private shared cache memory.

### SUMMARY OF THE DISCLOSURE

Aspects disclosed herein involve self-aware, peer-to-peer cache transfers between local, shared cache memories in a multi-processor system. In this regard, the multi-processor system includes a plurality of central processing units (CPUs) (i.e., processors) that are communicatively coupled to a shared communications bus for accessing memory external to the CPUs. A shared cache memory system is provided in the multi-processor system for increased cache memory capacity utilization. The shared cache memory system is formed by a plurality of local shared cache memories that are each local to an associated CPU in the multi-processor system. When a CPU in the multi-processor system desires to transfer cache data from its local, shared cache memory, such as in response to a cache data eviction, the CPU acts as a master CPU. In this regard, the master CPU issues a cache transfer request to another target CPU acting as a snoop processor to attempt to transfer the evicted cache data to a local, shared cache memory of another target CPU. To avoid the master CPU having to pre-select a target CPU for the cache transfer without knowing if the target CPU will accept the cache transfer request, the master CPU is configured to issue a cache transfer request on the shared communications bus in a peer-to-peer communication. Other target CPUs acting as snoop processors are configured to snoop the cache transfer request issued by the master CPU and self-determine acceptance of the cache transfer request. The target CPU responds to the cache transfer request in a cache transfer snoop response issued on the shared communications bus indicating if the target CPU will accept the cache transfer. For example, a target CPU may decline the cache transfer if acceptance would adversely affect its performance to avoid or mitigate sub-optimal performance in the target CPU. The master and target CPUs can observe the cache transfer snoop responses from other target CPUs to know which target CPUs are willing to accept the cache transfer. Thus, the master CPU and other target CPUs are “self-aware” of the intentions of the other target CPUs to accept or decline the cache transfer, which can avoid the master CPU having to make multiple requests to find a target CPU willing to accept the cache data transfer.

In this regard in one aspect, a multi-processor system is provided. The multi-processor system comprises a shared communications bus. The multi-processor system also comprises a plurality of CPUs communicatively coupled to the shared communications bus, wherein at least two CPUs among the plurality of CPUs are each associated with a local, shared cache memory configured to store cache data. A master CPU among the plurality of CPUs is configured to issue a cache transfer request for a cache entry in its associated respective local, shared cache memory, on the shared communications bus to be snooped by one or more target CPUs among the plurality of CPUs. The master CPU is also configured to observe one or more cache transfer snoop responses from the one or more target CPUs in response to issuance of the cache transfer request, each of the one or more cache transfer snoop responses indicating a respective target CPU's willingness to accept the cache transfer request. The master CPU is also configured to determine if at least one target CPU among the one or more target CPUs indicated a willingness to accept the cache transfer request based on the observed one or more cache transfer snoop responses.

In another aspect, a multi-processor system is provided. The multi-processor system comprises means for sharing communications. The multi-processor system also comprises a plurality of means for processing data communicatively coupled to the means for sharing communications, wherein at least two means for processing data among the plurality of means for processing data are each associated with a local, shared means for storing cache data. The multi-processor system also comprises a means for processing data among the plurality of means for processing data. The means for processing data comprises means for issuing a cache transfer request for a cache entry in its associated respective local, shared means for storing cache data, on a shared communications bus to be snooped by one or more target means for processing data among the plurality of means for processing data. The master means for processing data also comprises means for observing one or more cache transfer snoop responses from the one or more target means for processing data in response to the means for issuing the cache transfer request, each of the means for observing the one or more cache transfer snoop responses indicating a respective target means for processing data's willingness to accept the means for issuing the cache transfer request. The master means for processing data also comprises means for determining if at least one target means for processing data among the one or more target means for processing data indicated a willingness to accept the means for issuing the cache transfer request based on the means for observing the one or more of cache transfer snoop responses.

In another aspect, a method for performing cache transfers between local, shared cache memories in a multi-processor system is provided. The method comprises issuing a cache transfer request for a cache entry in an associated respective local, shared cache memory associated with a master CPU among a plurality of CPUs communicatively coupled to a shared communications bus, on the shared communications bus to be snooped by one or more target CPUs among the plurality of CPUs. The method also comprises observing one or more cache transfer snoop responses from the one or more target CPUs in response to issuance of the cache transfer request, each of the one or more cache transfer snoop responses indicating a respective target CPU's willingness to accept the cache transfer request. The method also comprises determining if at least one target CPU among the one or more target CPUs indicated a willingness to accept the cache transfer request based on the observed one or more cache transfer snoop responses.

### BRIEF DESCRIPTION OF THE FIGURES

FIG. 1 is a block diagram of an exemplary multiple (multi)-processor system having a plurality of central processing units (CPUs) each having a local, private cache memory and a shared, public cache memory;

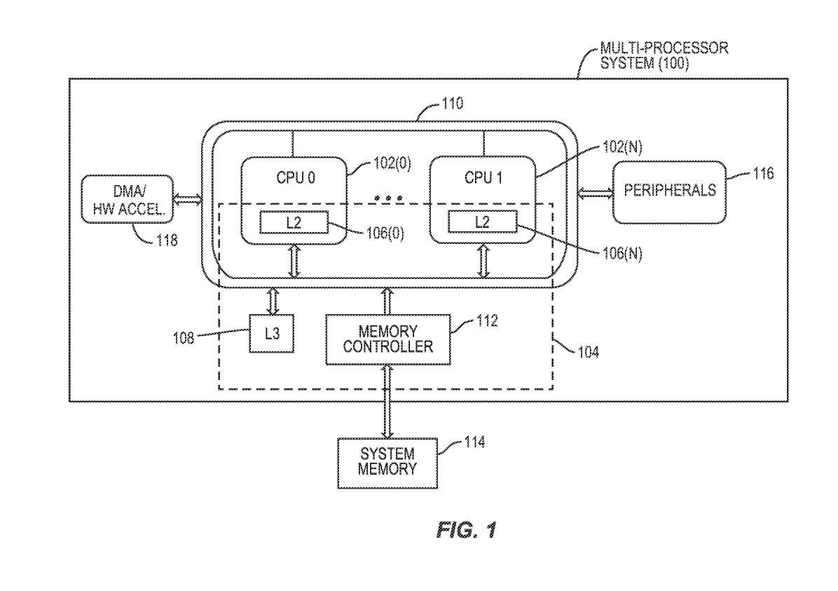

FIG. 2 is a block diagram of an exemplary multi-processor system having a plurality of CPUs, wherein one or more of the CPUs acting as a master CPU is configured to issue a cache transfer request to other target CPUs configured to receive the cache transfer and self-determine acceptance of the requested cache transfer based on a predefined target CPU selection scheme;

FIG. 3A is a flowchart illustrating an exemplary process of the master CPU in FIG. 2 issuing a cache transfer request to a target CPU(s);

FIG. 3B is a flowchart illustrating an exemplary process of a target CPU(s) in FIG. 2, acting as a snoop processor, snooping a cache transfer request issued by the master CPU and self-determining acceptance of the cache transfer request based on a predefined target CPU selection scheme;

FIG. 4 illustrates an exemplary message flow in the multi-processor system in FIG. 2 of a master CPU issuing a cache state transfer request to target CPUs in response to a cache miss to a cache entry in its associated respective local, shared cache memory, and the target CPUs determining acceptance of the cache state transfer request based on a predefined target CPU selection scheme;

FIG. 5A is a flowchart illustrating an exemplary process of the master CPU in FIG. 4 issuing a cache state transfer request to target CPUs in response to a cache miss to a cache entry in its associated respective local, shared cache memory;

FIG. 5B is a flowchart illustrating an exemplary process of a target CPU(s) in FIG. 4, acting as a snoop processor, snooping a cache state transfer request issued by the master CPU and self-determining acceptance of the cache state transfer request based on a predefined target CPU selection scheme;

FIG. 6 illustrates an exemplary cache transfer response issued by the target CPU in FIG. 4 indicating the target CPUs that can accept the cache state transfer request issued by the master CPU;

FIG. 7 is an exemplary pre-configured CPU position table accessible by the CPUs in the multi-processor system in FIG. 4 indicating the relative positions of the CPUs to each other to be used to determine which target CPU will be deemed to accept a cache transfer request when multiple target CPUs can accept the cache transfer request;

FIG. 8 illustrates an exemplary message flow in the multi-processor system in FIG. 2 of a master CPU issuing a cache data transfer request to target CPUs in response to a cache miss to a cache entry in its associated respective local, shared cache memory, and the target CPUs determining acceptance of the cache data transfer request based on a predefined target CPU selection scheme;

FIG. 9A is a flowchart illustrating an exemplary process of the master CPU in FIG. 8 issuing a cache data transfer request to target CPUs in response to a cache miss to a cache entry in its associated respective local, shared cache memory;

FIG. 9B is a flowchart illustrating an exemplary process of a target CPU(s) in FIG. 8, acting as a snoop processor, snooping a cache data transfer request issued by the master CPU and self-determining acceptance of the cache data transfer request based on a predefined target CPU selection scheme;

FIG. 10 illustrates an exemplary cache transfer snoop response issued by the target CPU in FIG. 8 indicating the target CPUs that can accept the cache data transfer request issued by the master CPU;

FIG. 11A is a flowchart illustrating an exemplary process of the master CPU in FIG. 2 issuing a combined cache state/data transfer request to target CPUs in response to a cache miss to a cache entry in its associated respective local, shared cache memory;

FIG. 11B is a flowchart illustrating an exemplary process of a target CPU(s) in FIG. 2, acting as a snoop processor, snooping a combined cache state/data transfer request issued by the master CPU and self-determining acceptance of the combined cache state/data transfer request based on a predefined target CPU selection scheme;

FIG. 11C is a flowchart illustrating an exemplary process of a memory controller in FIG. 2, acting as a snoop processor, snooping a combined cache state/data transfer request issued by the master CPU and self-determining acceptance of the combined cache state/data transfer request based on whether any of the other target CPUs accept the combined cache state/data transfer request; and

FIG. 12 is a block diagram of an exemplary processor-based system that can include a multi-processor system having a plurality of CPUs, wherein one or more of the CPUs acting as a master CPU is configured to issue a cache transfer request to other target CPUs configured to receive the cache transfer request and self-determine acceptance of the requested cache transfer request based on a predefined target CPU selection scheme, including but not limited to the multi-processor systems in FIGS. 2, 4, and 8.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

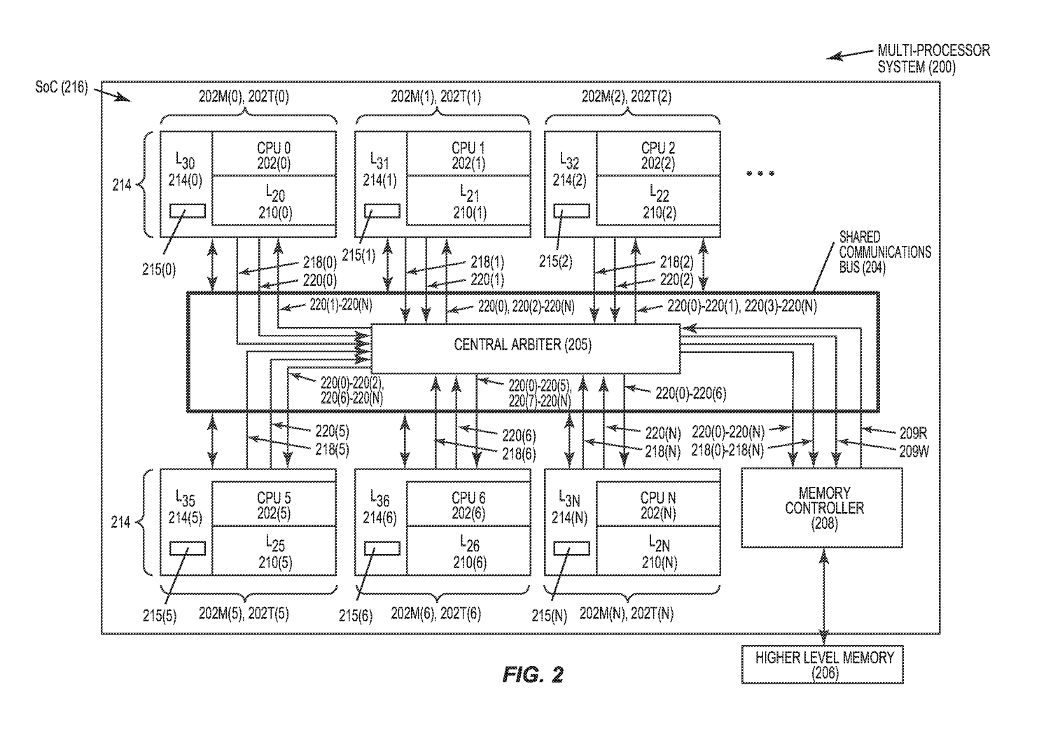

FIG. 2 is a block diagram of an exemplary multi-processor system 200 having a plurality of central processing units (CPUs) 202(0)-202(N) (i.e., processors 202(0)-202(N)). Each CPU 202(0)-202(N) is this example can be a processing core, wherein the multi-processor system 200 is a multi-core processing system. Each of the CPUs 202(0)-202(N) is communicatively coupled to a shared communications bus 204 for communicating between different CPUs 202(0)-202(N) and other external devices, such as to a higher level memory 206 external to the multi-processor system 200 (e.g., a system memory). The multi-processor system 200 includes a memory controller 208 communicatively coupled to the shared communications bus 204 for providing an interface between the CPUs 202(0)-202(N) and the higher level memory 206 for write data requests 209W and read data requests 209R to and from the higher level memory 206. A central arbiter 205 may be provided in the multi-processor system 200 as shown in FIG. 2 to direct communications from the shared communications bus 204 to and from the CPUs 202(0)-202(N) and the memory controller 208 in a point-to-point communication architecture. Alternatively, the CPUs 202(0)-202(N) and the memory controller 208 may be configured to implement a communications protocol for managing sent and received communications over the shared communications bus 204.

As part of the memory hierarchy of the multi-processor system 200, each CPU 202(0)-202(N) includes a respective local, “private” cache memory 210(0)-210(N) for storing cache data. The local, private cache memories 210(0)-210(N) may be level 2 (L2) cache memories shown as L₂₀-L_{2N} in FIG. 2, as an example. The local, private cache memories 210(0)-210(N) can be provided on-chip with and/or located physically close to their respective CPU 202(0)-202(N) to reduce access latencies. By “private,” it is meant that the local, private cache memories 210(0)-210(N) are used solely by its respective local CPU 202(0)-202(N) for storing cache data. Thus, the capacity of the local, private cache memories 210(0)-210(N) is not shared between CPUs 202(0)-202(N) in the multi-processor system 200. The local, private cache memories 210(0)-210(N) can be snooped by other CPUs 202(0)-202(N) over the shared communications bus 204, but cache data is not evicted to a local, private cache memory 210(0)-210(N) from another CPU 202(0)-202(N).

To provide for a shared cache memory that is accessible by each of the CPUs 202(0)-202(N) for improved cache memory capacity utilization, the multi-processor system 200 also includes a shared cache memory 214. In this example, the shared cache memory 214 is provided in the form of local, shared cache memories 214(0)-214(N) that may be located physically near, and are associated (i.e., assigned) to one or more of the respective CPUs 202(0)-202(N). The local, shared cache memories 214(0)-214(N) are a higher level cache memory (e.g., Level 3 (L3) shown as L₃₀-L_{3N}) than the local, private cache memories 210(0)-210(N) in this example. By “shared,” it is meant that each local, shared cache memory 214(0)-214(N) in the shared cache memory 214 can be accessed over the shared communications bus 204 for increased cache memory utilization. In this example, each CPU 202(0)-202(N) is associated with a respective local, shared cache memory 214(0)-214(N) such that each CPU 202(0)-202(N) is associated with a dedicated, local shared cache memory 214(0)-214(N) for data accesses. However, note that the multi-processor system 200 could be configured such that a local, shared cache memory 214 is associated (i.e., shared) with more than one CPU 202 that is configured to access such local, shared cache memory 214 for data requests that result in a miss to their respective local, private cache memories 210. In other words, multiple CPUs 202 in the multi-processor system 200 may be organized into subsets of CPUs 202, wherein each subset is associated with the same, common, local, shared cache memory 214. In this case, a CPU 202(0)-202(N) acting as a master CPU 202M is configured to request peer-to-peer cache transfers to other local, shared cache memories 214(0)-214(N) that are not associated with the master CPU 202M and are associated with one or more other target CPUs 202T(0)-202T(N).

With continuing reference to FIG. 2, the local, shared cache memories 214(0)-214(N) can be used by other CPUs 202(0)-202(N), including for storing evictions from their associated respective local, shared cache memory 214(0)-214(N) via a peer-to-peer transfer, as discussed in more detail below. However, to reduce memory access latencies to the shared cache memory 214, each local, shared cache memory 214(0)-214(N) can also be accessed by its respective CPU 202(0)-202(N) without access to the shared communications bus 204. For example, local, shared cache memory 214(0) can be accessed by CPU 202(0) without accessing the shared communications bus 204 in response to a cache miss to local, private cache memory 210(0) for a data read request by CPU 202(0). In this example, the local, shared cache memory 214(0) is a victim cache. The local, shared cache memories 214(0)-214(N) can be provided on-chip with the CPUs 202(0)-202(N) and/or the multi-processor system 200, as part of a system-on-a-chip (SoC) 216 for example.

With continuing reference to FIG. 2, cache entry (e.g., cache line) evictions from the local, private cache memories 210(0)-210(N) are evicted back to an associated local, shared cache memory 214(0)-214(N). To evict a cache entry from a respective local, private cache memory 210(0)-210(N) to an associated respective local, shared cache memory 214(0)-214(N), an existing cache entry 215(0)-215(N) in the associated respective local, shared cache memory 214(0)-214(N) may need to also be evicted. Providing the shared cache memory 214(0)-214(N) allows an evicted cache entry from a local, shared cache memory 214(0)-214(N) to be stored in another target local, shared cache memory 214(0)-214(N) associated with another CPU 202(0)-202(N) via a cache data transfer request provided over the shared communications bus 204. However, if the evicting CPU 202(0)-202(N) does not know if another particular pre-selected CPU 202(0)-202(N) selected to receive the cache data transfer has the spare capacity in its local, shared cache memory 214(0)-214(N) and/or spare processing time to store the evicted cache data, the cache eviction may fail. The pre-selected CPU 202(0)-202(N) may not accept the cache transfer. Thus, the evicting CPU 202(0)-202(N) may have to retry the cache eviction to another local, shared cache memory 214(0)-214(N) and/or to the memory controller 208 to be stored in the higher level memory 206 more often, thereby increasing cache memory access latencies.

In this regard, the multi-processor system 200 in FIG. 2 is configured to perform self-aware, peer-to-peer cache transfers between the local, shared cache memories 214(0)-214(N) in the shared cache memory 214. As will be discussed in more detail below, when a particular CPU 202(0)-202(N) in the multi-processor system 200 desires to perform a cache transfer from its associated respective local, shared cache memory 214(0)-204(N) (e.g., cache data eviction), the CPU 202(0)-202(N) acts as a master CPU 202M(0)-202M(N). Any of the CPUs 202(0)-202(N) can act as a master CPU 202M(0)-202M(N) when performing a cache transfer request. A master CPU 202M(0)-202M(N) issues a cache transfer request to one or more other CPUs 202(0)-202(N) acting as target CPUs 202T(0)-202T(N). The target CPUs 202T(0)-202T(N) act as snoop processors to snoop the cache transfer request from a master CPU 202M(0)-202M(N). To avoid a master CPU 202M(0)-202M(N) having to pre-select a particular target CPU 202T(0)-202T(N) for the cache transfer without knowing if the selected target CPU 202T(0)-202T(N) will accept the cache transfer request, the CPUs 202(0)-202(N), when acting as master CPUs 202M(0)-202M(N), are configured to issue a respective cache transfer request 218(0)-218(N) on the shared communications bus 204 to be received by the other CPUs 202(0)-202(N) acting as target CPUs 202T(0)-202T(N) in a peer-to-peer communication.

The cache transfer request 218(0)-218(N) is received and managed by the central arbiter 205 in this example. The central arbiter 205 is configured to provide the cache transfer requests 218(0)-218(N) to the target CPUs 202T(0)-202T(N) to be snooped. As will be discussed in more detail below, the target CPUs 202T(0)-202T(N) are configured to self-determine acceptance of a cache transfer request 218(0)-218(N). For example, a target CPU 202T(0)-202T(N) may decline a cache transfer request 218(0)-218(N) if acceptance would adversely affect its performance. The target CPUs 202T(0)-202T(N) respond to the cache transfer request 218(0)-218(N) in a respective cache transfer snoop response 220(0)-220(N) issued on the shared communications bus 204 (through the central arbiter 205 in this example) indicating if the respective target CPU 202T(0)-202T(N) is willing to accept the cache transfer. The issuing master CPU 202M(0)-202M(N) and the target CPUs 202T(0)-202T(N) can observe the cache transfer snoop responses 220(0)-220(N) from the other target CPUs 202T(0)-202T(N) to know which target CPUs 202T(0)-202T(N) are willing to accept the cache transfer. For example, CPU 202(1) acting as a target CPU 202T(1) snoops cache transfer snoop responses 220(0), 220(2)-220(N) from CPUs 202(0), 202(2)-202(N), respectively. Thus, the master CPU 202M(0)-202M(N) and other target CPUs 202T(0)-202T(N) are “self-aware” of the intentions of the other target CPUs 202T(0)-202T(N) to accept or decline the cache transfer. This can avoid a master CPU 202M(0)-202M(N) having to make multiple requests to find a target CPU 202T(0)-202T(N) willing to accept the cache transfer and/or having to transfer the cache data to the higher level memory 206.

If only one target CPU 202T(0)-202T(N) indicates a willingness to accept a cache transfer request 218(0)-218(N) issued by a respective master CPU 202M(0)-202M(N), the master CPU 202M(0)-202M(N) performs the cache transfer with the accepting target CPU 202T(0)-202T(N). The master CPU 202M(0)-202M(N) is “self-aware” that the target CPU 202T(0)-202T(N) that indicated a willingness to accept the cache transfer request 218(0)-218(N) will accept the cache transfer. However, if more than one target CPU 202T(0)-202T(N) indicates a willingness to accept a cache transfer request 218(0)-218(N) from a respective master CPU 202M(0)-202M(N), the accepting target CPUs 202T(0)-202T(N) can each be configured to employ a predefined target CPU selection scheme to determine which target CPU 202T(0)-202T(N) among the accepting target CPUs 202T(0)-202T(N) will accept the cache transfer from the master CPU 202M(0)-202M(N). The predefined target CPU selection scheme executed by the target CPUs 202T(0)-202T(N) is based on the cache transfer snoop responses 220(0)-220(N) snooped from the other target CPUs 202T(0)-202T(N). For example, the predefined target CPU selection scheme may provide that the target CPU 202T(0)-202T(N) willing to accept the cache transfer and located closest to the master CPU 202M(0)-202M(N) be deemed to accept the cache transfer to minimize cache transfer latency. Thus, the target CPUs 202T(0)-202T(N) are “self-aware” of which target CPU 202T(0)-202T(N) will accept the cache transfer request 218(0)-218(N) from a respective issuing master CPU 202M(0)-202M(N) for processing efficiency and to reduce bus traffic on the shared communications bus 204.

If no target CPU 202T(0)-202T(N) indicates a willingness to accept a cache transfer request 218(0)-218(N) from a respective master CPU 202M(0)-202M(N), the master CPU 202M(0)-202M(N) can issue the respective cache transfer request 218(0)-218(N) to the memory controller 208 for eviction to the higher level memory 206. In each of the scenarios discussed above, the master CPU 202M(0)-202M(N) does not have to pre-select a target CPU 202T(0)-202T(N) for a cache transfer without knowing if the target CPUs 202T(0)-202T(N) will accept the cache transfer, thus reducing memory access latencies associated with avoiding cache transfer retries and reduced bus traffic on the shared communications bus 204.

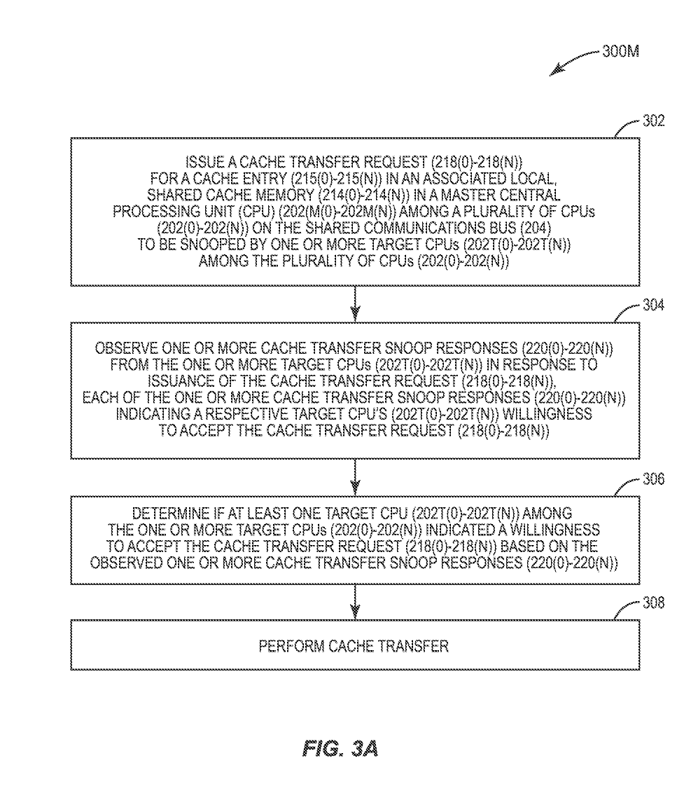

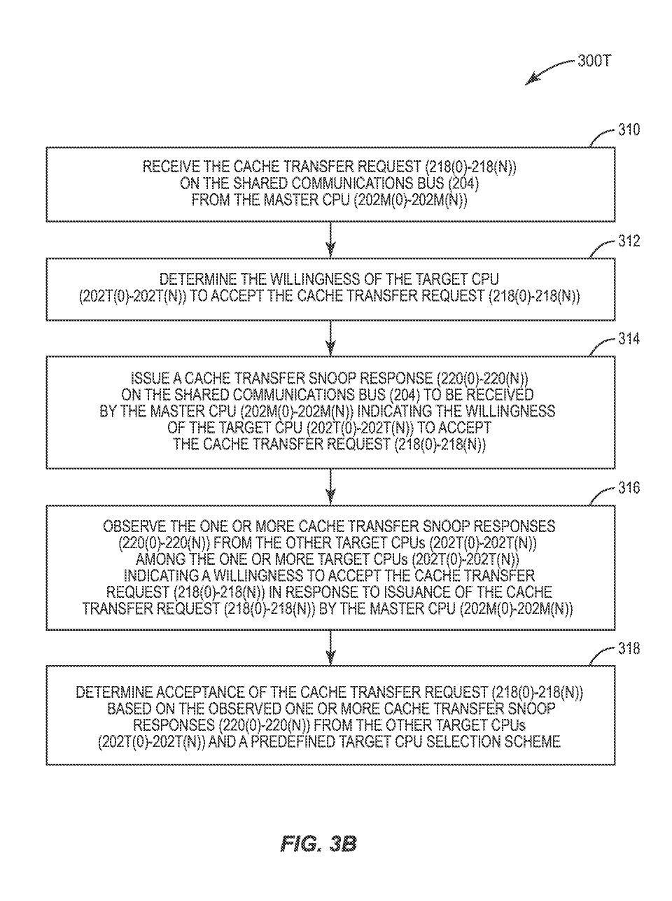

To further explain the ability of the multi-processor system 200 in FIG. 2 to perform self-aware, peer-to-peer cache transfers between the local, shared cache memories 214(0)-214(N) in the shared cache memory 214, FIGS. 3A and 3B are provided. FIG. 3A is a flowchart illustrating an exemplary master CPU process 300M of a master CPU 202M issuing a cache transfer request 218(0)-218(N) to a target CPU(s) 202T(0)-202T(N). FIG. 3B is a flowchart illustrating an exemplary target CPU process 300T of a target CPU(s) 202T(0)-202T(N), acting as a snoop processor, snooping a cache transfer request 218(0)-218(N) issued by the master CPU 202M and self-determining acceptance of the cache transfer request 218(0)-218(N) based on a predefined target CPU selection scheme. The master and target CPU processes 300M, 300T in FIGS. 3A and 3B will now be described with reference to the multi-processor system 200 in FIG. 2.

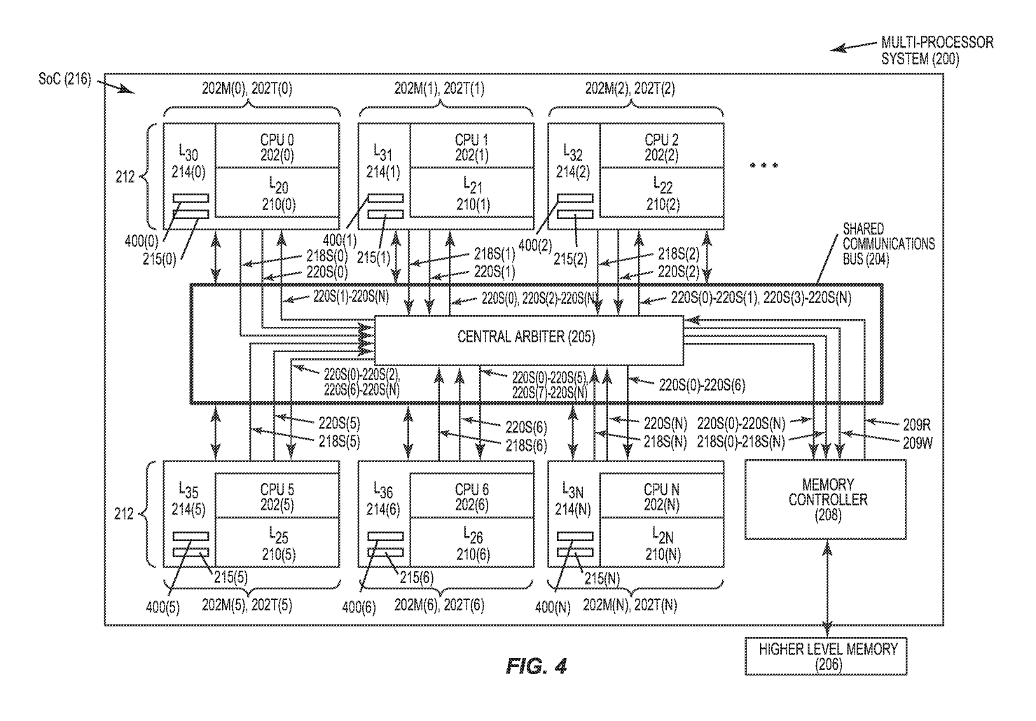

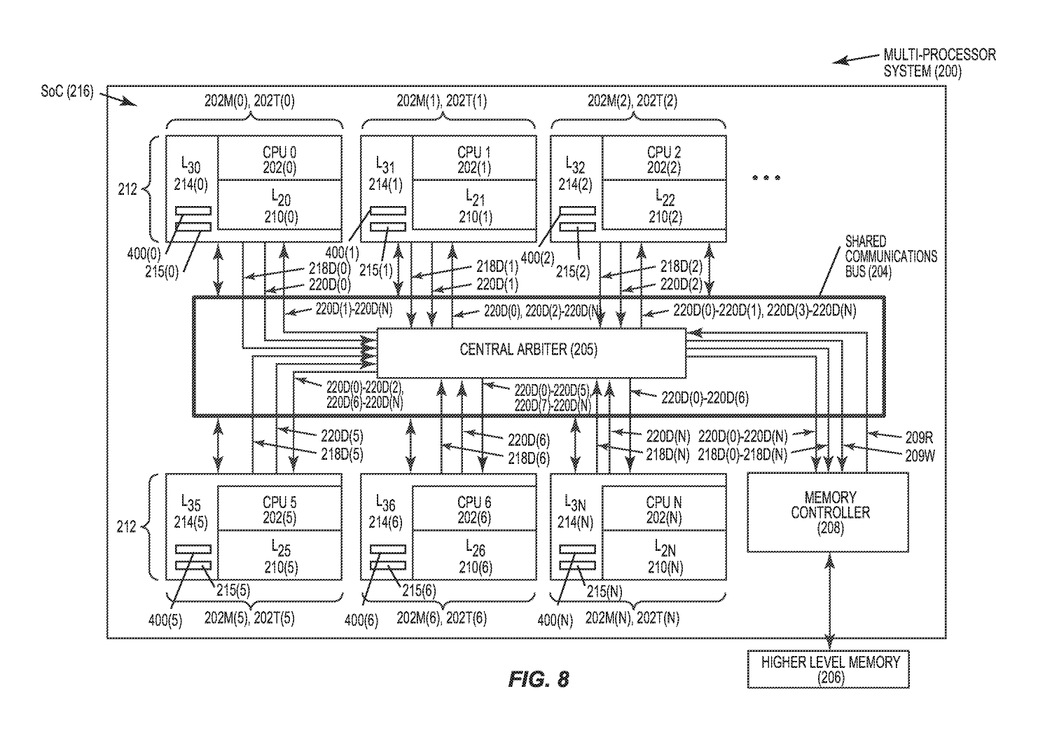

In this regard, as illustrated in the master CPU process 300M in FIG. 3A, a CPU 202 among the plurality of CPUs 202(0)-202(N) that desires to perform a cache transfer acts as a master CPU 202M(0)-202M(N). A respective master CPU 202M(0)-202M(N) issues a cache transfer request 218(0)-218(N) for a cache entry 215(0)-215(N) in its associated respective local, shared cache memory 214(0)-214(N) on the shared communications bus 204 to be snooped by one or more target CPUs 202T(0)-202T(N) among the plurality of CPUs 202(0)-202(N) (block 302 in FIG. 3A). For example, a master CPU 202M(0)-202M(N) may desire to perform a cache transfer in response to an eviction of cache data from its associated respective local, shared cache memory 214(0)-214(N). As will be discussed in more detail below with regard to FIGS. 4-7 for example, if cache data to be evicted from the associated respective local, shared cache memory 214(0)-214(N) is in a shared cache state, the cache data may be stored in another local, shared cache memory 214(0)-214(N). Thus, the cache transfer may simply involve changing a cache state of the cache data stored in the cache entry 215(0)-215(N) to be evicted from the local, shared cache memory 214(0)-214(N). However, as discussed below with regard to FIGS. 8-10 for example, if the cache data to be evicted from the associated respective local, shared cache memory 214(0)-214(N) is in an exclusive or unique cache state, the cache data is not stored in another local, shared cache memory 214(0)-214(N). Or as other examples, even if the cache data to be evicted from the associated local, shared cache memory 214(0)-214(N) is in a shared cache state, another local, shared cache memory 214(0)-214(N) may not contain a copy of the cache data or may not be willing to accept the evicted cache data. Thus, the cache transfer in this instance will involve transferring the cache data stored in the associated cache entry 215(0)-215(N) to be evicted from the associated respective local, shared cache memory 214(0)-214(N).

The master CPU 202M(0)-202M(N) will then observe one or more cache transfer snoop responses 220(0)-220(N) from one or more target CPUs 202T(0)-202T(N) in response to issuance of the respective cache transfer request 218(0)-218(N) (block 304 in FIG. 3A). Each of the cache transfer snoop responses 220(0)-220(N) indicates a respective target CPU's 202T(0)-202T(N) willingness to accept the cache transfer request 218(0)-218(N). The master CPU 202M(0)-202M(N) then determines if at least one target CPU 202T(0)-202T(N) among the target CPUs 202T(0)-202T(N) indicated a willingness to accept the respective cache transfer request 218(0)-218(N) based on the observed cache transfer snoop responses 220(0)-220(N) from the target CPUs 202T(0)-202T(N) (block 306 in FIG. 3A). Thus, the master CPU 202M(0)-202M(N) is self-aware of target CPUs 202T(0)-202T(N) willing to accept the cache transfer request 218(0)-218(N). The master CPU 202M(0)-202M(N) can then perform the cache transfer to another local, shared cache memory 214(0)-214(N) if at least one target CPU 202T(0)-202T(N) indicated a willingness to accept the respective cache transfer request 218(0)-218(N) (block 308 in FIG. 3A). Examples of these next steps will be discussed in more detail below starting at FIG. 4. If based on the observed cache transfer snoop responses 220(0)-220(N), none of the target CPU 202T(0)-202T(N) indicated a willingness to accept the cache transfer request 218(0)-218(N), the master CPU 202M(0)-202M(N) can send the cache transfer request 218(0)-218(N) to the memory controller 208 to evict the cache data to the higher level memory 206.

The target CPUs 202T(0)-202T(N) are each configured to perform the target CPU process 300T in FIG. 3B in response to issuance of a respective cache transfer request 218(0)-218(N) by a master CPU 202M(0)-202M(N) according to the master CPU process 300M in FIG. 3A. When one CPU 202(0)-202(N) acts as a master CPU 202M(0)-202M(N), the other CPUs 202(0)-202(N) act as target CPUs 202T(0)-202T(N). The target CPUs 202T(0)-202T(N) receive the cache transfer request 218(0)-218(N) issued by the master CPU 202M(0)-202M(N) on the shared communications bus 204 (block 310 in FIG. 3B). The target CPUs 202T(0)-202T(N) determine their willingness to accept the respective cache transfer request 218(0)-218(N) (block 312 in FIG. 3B). For example, a target CPU 202T(0)-202T(N) may determine whether to accept a cache transfer request 218(0)-218(N) based on whether the target CPU 202T(0)-202T(N) already has a copy of the cache entry 215(0)-215(N) to be transferred. As another example, a target CPU 202T(0)-202T(N) may determine whether to accept a cache transfer request 218(0)-218(N) based on the current performance demands on the target CPU 202T(0)-202T(N) at the time that the cache transfer request 218(0)-218(N) is received. In these examples, the target CPU 202T(0)-202T(N) uses its own criteria and rules to determine if the target CPU 202T(0)-202T(N) is willing to accept a cache transfer request 218(0)-218(N).

The target CPUs 202T(0)-202T(N) then issue a cache transfer snoop response 220(0)-220(N) on the shared communications bus 204 to be received by the master CPU 202M(0)-202M(N) indicating the willingness of the target CPU 202T(0)-202T(N) to accept the respective cache transfer request 218(0)-218(N) (block 314 in FIG. 3B). The target CPUs 202T(0)-202T(N) also observe cache transfer snoop responses 220(0)-220(N) from the other target CPUs 202T(0)-202T(N) indicating a willingness of those other target CPUs 202T(0)-202T(N) to accept the cache transfer request 218(0)-218(N) (block 316 in FIG. 3B). Each target CPU 202T(0)-202T(N) then determines acceptance of the cache transfer request 218(0)-218(N) based on the observed cache transfer snoop responses 220(0)-220(N) from the other target CPUs 202T(0)-202T(N) and a predefined target CPU selection scheme (block 318 in FIG. 3B). In one example, the target CPUs 202T(0)-202T(N) each have the same predefined target CPU selection scheme so that each target CPU 202T(0)-202T(N) will be “self-aware” of which target CPU 202T(0)-202T(N) will accept the cache transfer request 218(0)-218(N).

Further, the master CPU 202M(0)-202M(N) may also have the same predefined target CPU selection scheme so that the master CPU 202M(0)-202M(N) will also be “self-aware” of which target CPU 202T(0)-202T(N) will accept the cache transfer request 218(0)-218(N). In this manner, the master CPU 202M(0)-202M(N) does not have to pre-select or guess as to which target CPU 202T(0)-202T(N) will accept the cache transfer request 218(0)-218(N). Also, the memory controller 208 may be configured to act as a snoop processor to snoop the cache transfer requests 218(0)-218(N) and the cache transfer snoop responses 220(0)-220(N) issued by any master CPU 202M(0)-202M(N) and the target CPUs 202T(0)-202T(N), respectively as shown in FIG. 2. In this regard, like the master CPU 202M(0)-202M(N), the memory controller 208 can be configured to determine if any of the target CPUs 202T(0)-202T(N) indicated a willingness to accept a cache transfer request 218(0)-218(N) from a master CPU 202M(0)-202M(N). If the memory controller 208 determines that no target CPUs 202T(0)-202T(N) indicated a willingness to accept a cache transfer request 218(0)-218(N) from a master CPU 202M(0)-202M(N), the memory controller 208 can accept the cache transfer request 218(0)-218(N) without the master CPU 202M(0)-202M(N) having to reissue the cache transfer request 218(0)-218(N) over the shared communications bus 204.

As discussed above, if the cache entry 215(0)-215(N) to be evicted from an associated respective local, shared cache memory 214(0)-214(N) is in a shared state, the cache entry 215(0)-215(N) may already be present in another local, shared cache memory 214(0)-214(N). Thus, the CPUs 202(0)-202(N) when acting as master CPUs 202M(0)-202M(N) can be configured to issue a cache state transfer request to transfer the state of the evicted cache entry 215(0)-215(N), as opposed to a cache data transfer. In this manner, a CPU 202(0)-202(N) acting as a target CPU 202T(0)-202T(N) that accepts the cache state transfer request in a “self-aware” manner can update the cache entry 215(0)-215(N) in its associated respective local, shared cache memory 214(0)-214(N) as part of the cache state transfer, as opposed to storing the cache data for the evicted cache entry 215(0)-215(N). Further, a CPU 202(0)-202(N) acting as a master CPU 202T(0)-202T(N) can be “self-aware” of the acceptance of the cache state transfer request by another target CPU 202T(0)-202T(N) without having to transfer the cache data for the evicted cache entry 215(0)-215(N) to the target CPU 202T(0)-202T(N).

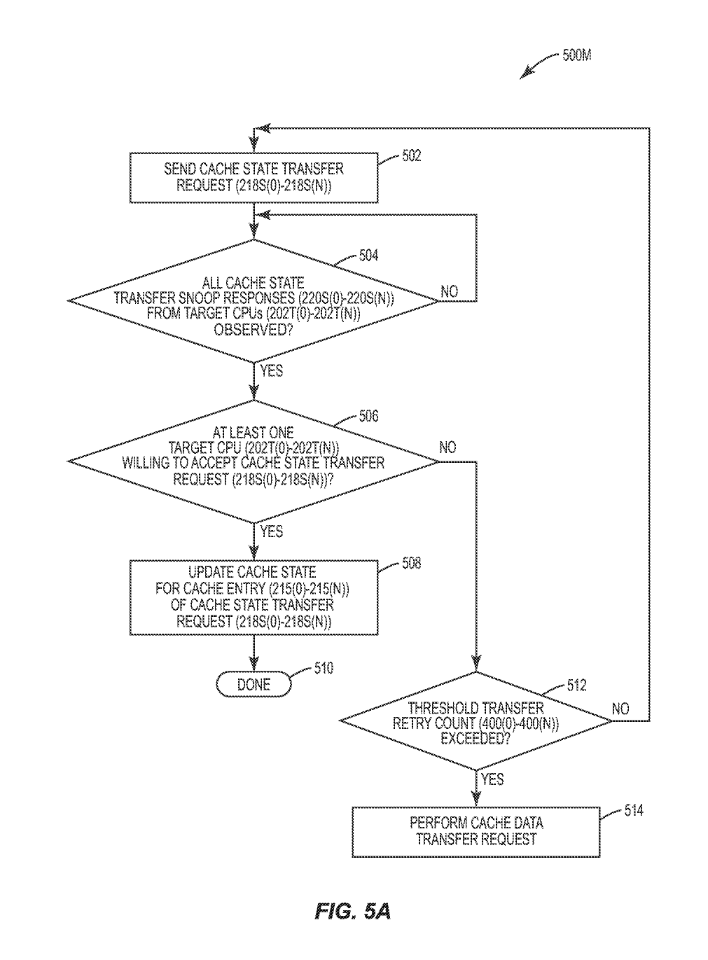

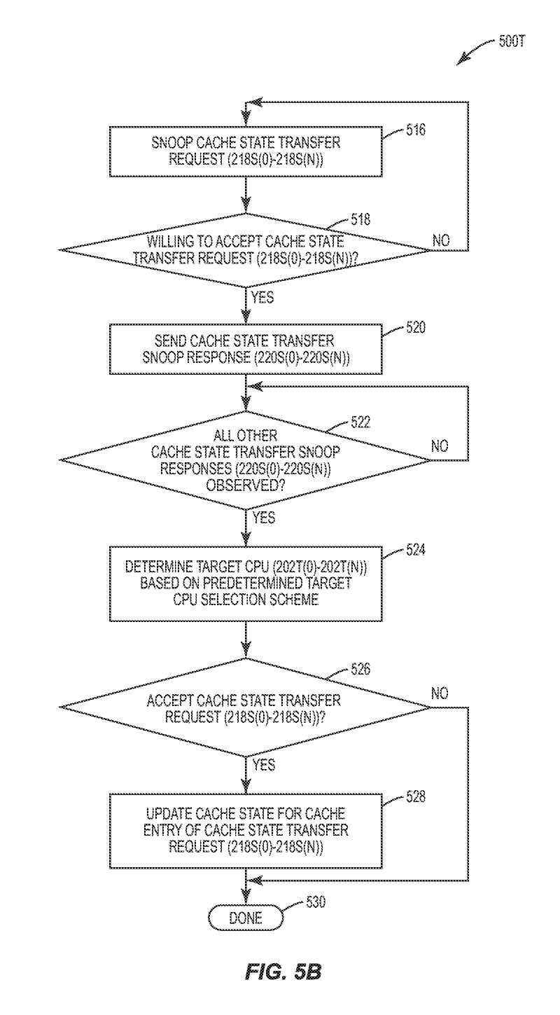

In this regard, FIG. 4 illustrates the multi-processor system 200 of FIG. 2 wherein a master CPU 202M(0)-202M(N) is configured to issue a respective cache state transfer request 218S(0)-218S(N) to other CPUs 202(0)-202(N) acting as target CPUs 202T(0)-202T(N). The cache state transfer request 218S(0)-218S(N) may be issued in response to a cache miss to a cache entry in an associated respective local, shared cache memory 214(0)-214(N) as an example. The cache miss to a cache entry 215(0)-215(N) in an associated respective local, shared cache memory 214(0)-214(N) may be preceded by a cache miss to a respective local, private cache memory 210(0)-210(N). The target CPUs 202T(0)-202T(N) will snoop the cache state transfer request 218S(0)-218S(N). The target CPUs 202T(0)-202T(N) will then determine their willingness to accept the cache state transfer request 218S(0)-218S(N) for the cache entry 215(0)215(N) based on a predefined target CPU selection scheme. As discussed in more detail below, each target CPU 202T(0)-202T(N) in this example includes a respective threshold transfer retry count 400(0)-400(N) that is used to indicate the target CPUs' 202T(0)-202T(N) willingness to accept a cache state transfer request 218S(0)-218S(N). The target CPUs 202T(0)-202T(N) will indicate their willingness to accept the cache state transfer request 218S(0)-218S(N) in their respective cache state transfer snoop responses 220S(0)-220S(N) provided to the master CPU 202M(0)-202M(N) and other target CPUs 202T(0)-202T(N). The master CPU 202M(0)-202M(N) and other target CPUs 202T(0)-202T(N) will be self-aware of which target CPU 202T(0)-202T(N), if any, accepted the cache state transfer request 218S(0)-218S(N). FIG. 5A is a flowchart illustrating an exemplary master CPU process 500M of a master CPU 202M(0)-202M(N) in the multi-processor system 200 in FIG. 4 issuing a respective cache state transfer request 218S(0)-218S(N) to other CPUs 202(0)-202(N) acting as target CPUs 202T(0)-202T(N). A CPU 202 among the plurality of CPUs 202(0)-202(N) that desires to perform a cache state transfer acts as a master CPU 202M(0)-202M(N). A respective master CPU 202M(0)-202M(N) issues a cache state transfer request 218S(0)-218S(N) for a respective cache entry 215(0)-215(N) in its associated respective local, shared cache memory 214(0)-214(N) on the shared communications bus 204 to be snooped by one or more target CPUs 202T(0)-202T(N) among the plurality of CPUs 202(0)-202(N) (block 502 in FIG. 5A). For example, a master CPU 202M(0)-202M(N) may desire to perform a cache state transfer in response to an eviction of cache data having a shared cache state from its associated respective local, shared cache memory 214(0)-214(N).

The master CPU 202M(0)-202N(N) will then observe one or more cache state transfer snoop responses 220S(0)-220S(N) from one or more target CPUs 202T(0)-202T(N) in response to issuance of the cache state transfer request 218S(0)-218S(N) (block 504 in FIG. 5A). Each of the cache state transfer snoop responses 220S(0)-220S(N) indicates a respective target CPU's 202T(0)-202T(N) willingness to accept the cache state transfer request 218S(0)-218S(N). The master CPU 202M(0)-202M(N) then determines if at least one target CPU 202T(0)-202T(N) among the target CPUs 202T(0)-202T(N) indicated a willingness to accept the cache state transfer request 218S(0)-218S(N) based on the observed cache state transfer snoop responses 220S(0)-220S(N) from the target CPUs 202T(0)-202T(N) (block 506 in FIG. 5A). Thus, the master CPU 202M(0)-202M(N) is self-aware of the target CPUs 202T(0)-202T(N) willingness to accept the cache state transfer request 218S(0)-218S(N). If at least one target CPU 202T(0)-202T(N) indicated a willingness to accept the cache state transfer request 218S(0)-218S(N), the master CPU 202M(0)-202M(N) will update the cache state for the respective cache entry 215(0)-215(N) of the cache state transfer request 218S(0)-218S(N) to a shared cache state indicative of the confirmation that at least one target CPU 202T(0)-202T(N) had a copy of the evicted cache data (block 508 in FIG. 5A), and the process 500M is done (block 510 in FIG. 5A).

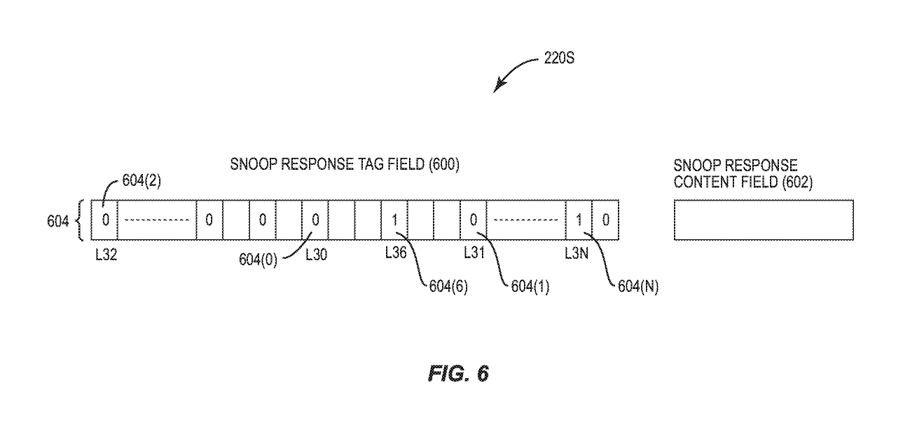

An example of a format of cache transfer snoop response 220S(0)-220S(N) that is issued by a target CPU 202T(0)-202T(N) in response to a received cache transfer request 218(0)-218(N) is shown in FIG. 6. The cache transfer snoop response format can be used for a cache state transfer snoop response 220S in response to a cache state transfer request 218S. As shown therein, the cache transfer snoop response 220S includes a snoop response tag field 600 and a snoop response content field 602. The snoop response tag field 600 in this example is comprised of a plurality of bits 604(0)-604(N). A bit 604 is assigned to each CPU 202(0)-202(N) to represent the willingness of that respective CPU 202(0)-202(N) to accept a cache state transfer request 218S. For example, bit 604(2) is assigned to CPU 202(2). Bit 604(0) is assigned to CPU 202(0), and so on. A bit value of ‘1’ in a bit 604 means that the target CPU 202T(0)-202T(N) assigned to such bit 604 is willing to accept the cache state transfer request 218S. A ‘0’ or null value in a bit 604 indicates that the target CPU 202T(0)-202T(N) assigned to such bit 604 is not willing to accept the cache state transfer request 218S. A target CPU 202T(0)-202T(N) asserts the bit value in their assigned bit 604 in the snoop response tag field 600 in a cache state transfer snoop response 220S. If more than one bit 604 is set in the cache transfer snoop response 220S, this means more than one target CPU 202T(0)-202T(N) has indicated a willingness to accept the cache state transfer request 218S(0)-218S(N). If only one bit 604 is set in the cache transfer snoop response 220S, this means only one target CPU 202T(0)-202T(N) has indicated a willingness to accept the cache state transfer request 218S(0)-218S(N). If no bits 604 are set in the cache transfer snoop response 220S, this means no target CPU 202T(0)-202T(N) has indicated a willingness to accept the cache state transfer request 218S(0)-218S(N). Thus, the master CPU 202M(0)-202M(N) and target CPUs 202T(0)-202T(N) can use the observed cache state transfer snoop responses 220S(0)-220S(N) to be self-aware of each target CPUs 202T(0)-202T(N) willingness to accept a cache state transfer request 218S(0)-218S(N).

With reference back to FIG. 5A, if in block 506, no observed cache state transfer snoop responses 220S(0)-220S(N) indicated a willingness of the target CPUs 202T(0)-202T(N) to accept the cache state transfer request 218S(0)-218S(N), the master CPU 202M(0)-202M(N) can choose to perform a cache data transfer request, an example of which is discussed in more detail below in FIGS. 8-10. Alternatively, the master CPU 202M(0)-202M(N) can choose to retry the cache state transfer request 218S(0)-218S(N). For example, the target CPUs 202T(0)-202T(N) may have a temporary performance or other issue that is preventing a willingness to accept the cache state transfer request 218S(0)-218S(N), but may be willing to accept the cache state transfer request 218S(0)-218S(N) at a later time during a retry. In this regard, in one example, the master CPU 202M(0)-202M(N) determines if a respective threshold transfer retry count 400(0)-400(N) is exceeded (block 512 in FIG. 5A). If not, the master CPU 202M(0)-202M(N) increments the respective threshold transfer retry count 400(0)-400(N) and reissues a next cache state transfer request 218S(0)-218S(N) request for the cache entry 215(0)-215(N) to be snooped by the target CPUs 202T(0)-202T(N). One or more next cache state transfer snoop responses 220S(0)-220S(N) from the target CPUs 202T(0)-202T(N) indicating a willingness to accept the retried next cache state transfer request 218S(0)-218S(N) are observed (blocks 502-506 in FIG. 5A).

If however, the respective threshold transfer retry count 400(0)-400(N) is exceeded (block 512 in FIG. 5A), the target CPU 202T(0)-202T(N) is configured to perform a cache data transfer request to attempt to move the cache data of the evicted cache entry 215(0)-215(N) to another local, shared cache memory 214(0)-214(N) and/or to the memory controller 208 (block 514 in FIG. 5A). An example of a cache data transfer request is described later below with regard to FIGS. 8-10.

FIG. 5B is a flowchart illustrating an exemplary target CPU process 500T of a target CPU 202T(0)-202T(N) in the multi-processor system 200 in FIG. 4, acting as a snoop processor. The target CPUs 202T(0)-202T(N) are each configured to perform the target CPU process 500T in FIG. 5B in response to issuance of a respective cache state transfer request 218S(0)-218S(N) by a master CPU 202M(0)-202M(N) according to the master CPU process 500M in FIG. 5A. In this regard, the target CPUs 202T(0)-202T(N) snoop the cache state transfer request 218S(0)-218S(N) issued by the master CPU 202M(0)-202M(N) on the shared communications bus 204 (block 516 in FIG. 5B). The target CPUs 202T(0)-202T(N) determine their willingness to accept the respective cache state transfer request 218S(0)-218S(N) (block 518 in FIG. 5B). For example, a target CPU 202T(0)-202T(N) may determine whether to accept a cache state transfer request 218S(0)-218S(N) based on whether the target CPU 202T(0)-202T(N) already has a copy of the cache entry 215(0)-215(N) to be transferred. As another example, a target CPU 202T(0)-202T(N) may determine whether to accept a cache state transfer request 218S(0)-218S(N) based on the current performance demands on the target CPU 202T(0)-202T(N) at the time that the cache state transfer request 218S(0)-218S(N) is received. In these examples, the target CPU 202T(0)-202T(N) uses its own criteria and rules to determine if the target CPU 202T(0)-202T(N) is willing to accept a cache transfer request 218S(0)-218S(N).

The target CPUs 202T(0)-202T(N) then issues a cache state transfer snoop response 220S(0)-220S(N) on the shared communications bus 204 to be observed by the master CPU 202M(0)-202M(N) indicating the willingness of the target CPU 202T(0)-202T(N) to accept the respective cache state transfer request 218S(0)-218S(N) (block 520 in FIG. 5B). The target CPUs 202T(0)-202T(N) also observe the cache state transfer snoop responses 220S(0)-220S(N) from the other target CPUs 202T(0)-202T(N) indicating a willingness of those other target CPUs 202T(0)-202T(N) to accept the caches state transfer request 218S(0)-218S(N) (block 522 in FIG. 5B). Each target CPU 202T(0)-202T(N) then determines acceptance of the cache state transfer request 218S(0)-218S(N) based on the observed cache state transfer snoop responses 220S(0)-220S(N) from the other target CPUs 202T(0)-202T(N) and a predefined target CPU selection scheme (block 524 in FIG. 5B).

In one example, the target CPUs 202T(0)-202T(N) each have the same predefined target CPU selection scheme so that each target CPU 202T(0)-202T(N) will be “self-aware” of which target CPU 202T(0)-202T(N) will accept the cache transfer request 218S(0)-218S(N). If only one target CPU 202T(0)-202T(N) indicates a willingness to accept a cache state transfer request 218S(0)-218S(N), then no decision is required as to which target CPU 202T(0)-202T(N) will accept. However, if more than one target CPU 202T(0)-202T(N) indicates a willingness to accept a cache state transfer request 218S(0)-218S(N), then the target CPU 202T(0)-202T(N) that indicates a willingness to accept the cache state transfer request 218S(0)-218S(N) employs a predefined target CPU selection scheme to determine if it will accept the cache state transfer request 218S(0)-218S(N). In this regard, the target CPUs 202T(0)-202T(N) will also be self-aware of which target CPU 202T(0)-202T(N) accepted the cache state transfer request 218S(0)-218S(N). The master CPU 202M(0)-202M(N) can employ the same predefined target CPU selection scheme to also be self-aware of which target CPU 202T(0)-202T(N) accepted the cache state transfer request 218S(0)-218S(N).

Different predefined target CPU selections schemes can be employed in the CPUs 202(0)-202(N) when acting as a target CPU 202T(0)-202T(N) to determine acceptance of a cache state transfer request 218S(0)-218S(N). As discussed above, if the target CPUs 202T(0)-202T(N) all employ the same predefined target CPU selection scheme, each target CPUs 202T(0)-202T(N) can determine and be self-aware of which target CPU 202T(0)-202T(N) will accept the cache state transfer request 218S(0)-218S(N). As also discussed above, the CPUs 202(0)-202(N) acting as a master CPU 202M(0)-202M(N) can also use the predefined target CPU selections schemes to be self-aware of which target CPU 202T(0)-202T(N), if any, will accept a cache state transfer request 218S(0)-218S(N). This information can be used to determine if a cache state transfer request 218S(0)-218S(N) should be retried and/or sent to the memory controller 208.

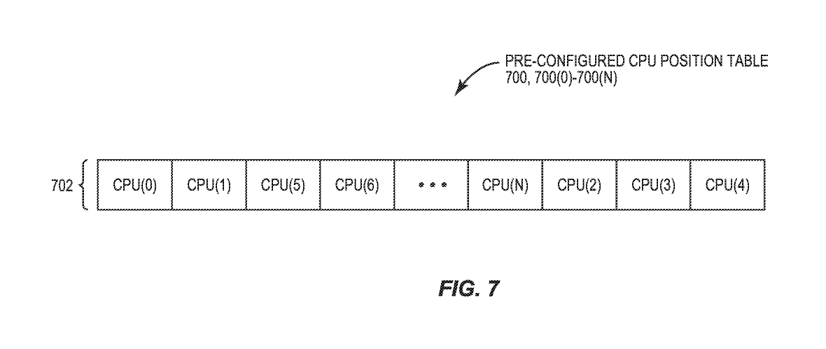

FIG. 7 illustrates a pre-configured CPU position table 700 as one example of a scheme that can be used for predefined target CPU selection scheme employed in the target CPUs 202T(0)-202T(N) to determine which target CPU 202T(0)-202T(N) will accept a cache state transfer request 218S(0)-218S(N). The pre-configured CPU position table 700 provides a logical position map indicating the relative position of the CPUs 202(0)-202(N) to each other. In this manner, any CPU 202(0)-202(N) can know the relative physical location and distance of all other CPUs 202(0)-202(N). For example, a predefined target CPU selection scheme may involve the target CPU 202T(0)-202T(N) located closest to a master CPU 202M(0)-202M(N) accepting a cache state transfer request 218S(0)-218S(N). For example, as shown in FIG. 7, the pre-configured CPU position table 700 includes entries 702 for each CPU 202(0)-202(N) when acting as a master CPU 202M(0)-202M(N) in the multi-processor system 200. For a given master CPU 202M(0)-202M(N), the closest target CPU 202T(0)-202T(N) is deemed the CPU 202(0)-202(N) to the right of the given master CPU 202M(0)-202M(N).

For example, if CPU 202(5) is the master CPU 202M(5) for a given cache transfer request 218(0)-218(N), CPU 202(6) will be deemed the closest CPU 202(6) to master CPU 202M(5). The last entry in the pre-configured CPU position table 700 (i.e., CPU 202(4) in FIG. 4) will be deemed to be closest to the CPU 202(3) to its left. Thus, for master CPU 202M(5), if target CPUs 202T(N) and 202T(1) are the only target CPUs 202T(0)-202T(N) to indicate a willingness to accept a cache state transfer request 218S(0)-218S(N), target CPU 202T(1) will accept the cache state transfer request 218S(0)-218S(N). The target CPU 202T(N) will be self-aware of target CPU's 202T(1) willingness to accept the cache state transfer request 218S(0)-218S(N) based on the cache state transfer snoop responses 220S(0)-220S(N) and use of the pre-configured CPU position table 700. The master CPU 202M(0)-202M(N) can also use a predefined target CPU selection scheme so that the master CPU 202M(N) in this example will also be “self-aware” that target CPU 202T(1) accepted the cache state transfer request 218S(0)-218S(N). In this manner, the master CPU 202M(5) does not have to pre-select or guess as to which target CPU 202T(0)-202T(N) accepted the cache state transfer request 218S(0)-218S(N).

A single copy of the pre-configured CPU position table 700 may be provided that is accessible to each CPU 202(0)-202(N) (e.g., located in the central arbiter 205). Alternatively, copies of the pre-configured CPU position table 700(0)-700(N) may be provided in each CPU 202(0)-202(N) to avoid accessing the shared communications bus 204 for access.

With reference back to FIG. 5B, if a target CPU 202T(0)-202T(N) determines that it will accept the cache state transfer request 218S(0)-218S(N) based on the predefined target CPU selection scheme, the target CPU 202T(0)-202T(N) updates the cache state of its respective cache entry 215(0)-215(N) to a shared cache state (block 528 in FIG. 5B), and the process 500T for that target CPU 202T(0)-202T(N) is done (block 530 in FIG. 5B). If a target CPU 202T(0)-202T(N) determines that it will not accept the cache state transfer request 218S(0)-218S(N) based on the predefined target CPU selection scheme, the process 500T for that target CPU 202T(0)-202T(N) is done (block 530 in FIG. 5B).

Also, the memory controller 208 may be configured to act as a snoop processor to snoop the cache state transfer requests 218S(0)-218S(N) and the cache state transfer snoop responses 220S(0)-220S(N) issued by any master CPU 202M(0)-202M(N) and the target CPUs 202T(0)-202T(N), respectively as shown in FIG. 4. In this regard, like the master CPU 202M(0)-202M(N), the memory controller 208 can be configured to determine if any of the target CPUs 202T(0)-202T(N) indicated a willingness to accept a cache state transfer request 218S(0)-218S(N) from a master CPU 202M(0)-202M(N). If the memory controller 208 determines that no target CPUs 202T(0)-202T(N) indicated a willingness to accept a cache state transfer request 218S(0)-218S(N) from a master CPU 202M(0)-202M(N), the memory controller 208 can accept the cache state transfer request 218S(0)-218S(N) without the master CPU 202M(0)-202M(N) having to reissue the cache state transfer request 218S(0)-218S(N) over the shared communications bus 204.

As discussed above, if the cache entry 215(0)-215(N) to be evicted from an associated respective local, shared cache memory 214(0)-214(N) is in an exclusive or unique (i.e. non-shared) state or in a shared state for a previous cache state transfer that failed, the cache entry 215(0)-215(N) is deemed to not already be present in another local, shared cache memory 214(0)-214(N). Thus, the CPUs 202(0)-202(N) when acting as master CPUs 202M(0)-202M(N) can be configured to issue a cache data transfer request to transfer the cache data of the evicted cache entry 215(0)-215(N). In this manner, a CPU 202(0)-202(N) acting as a target CPU 202T(0)-202T(N) that accepts the cache data transfer request in a “self-aware” manner can update its cache entry 215(0)-215(N) in its associated respective local, shared cache memory 214(0)-214(N) with the evicted cache state and data. Further, a CPU 202(0)-202(N) acting as a master CPU 202T(0)-202T(N) can be “self-aware” of the acceptance of the cache data transfer request by another target CPU 202T(0)-202T(N) so that the cache data for the evicted cache entry 215(0)-215(N) can be transferred to the target CPU 202T(0)-202T(N) that is known to be willing to accept the cache data transfer.

In this regard, FIG. 8 illustrates the multi-processor system 200 of FIG. 2 wherein a master CPU 202M(0)-202M(N) is configured to issue a respective cache data transfer request 218D(0)-218D(N) to other CPUs 202(0)-202(N) acting as target CPUs 202T(0)-202T(N). The cache data transfer request 218D(0)-218D(N) may be issued in response to a cache miss to a cache entry 215(0)-215(N) in a non-shared/exclusive state in an associated respective local, shared cache memory 214(0)-214(N) as an example. The cache miss to a cache entry 215(0)-215(N) in an associated respective local, shared cache memory 214(0)-214(N) may be preceded by a cache miss to a respective local, private cache memory 210(0)-210(N). The target CPUs 202T(0)-202T(N) will snoop the cache data transfer request 218D(0)-218D(N). The target CPUs 202T(0)-202T(N) will then determine their willingness to accept the cache data transfer request 218D(0)-218D(N) for the cache entry 215(0)-215(N) based on a predefined target CPU selection scheme. The target CPUs 202T(0)-202T(N) will then indicate their willingness to accept the cache data transfer request 218D(0)-218D(N) in their respective cache data transfer snoop responses 220D(0)-220D(N) that are provided to the master CPU 202M(0)-202M(N) and other target CPUs 202T(0)-202T(N). The master CPU 202M(0)-202M(N) and other target CPUs 202T(0)-202T(N) will be self-aware of which target CPU 202T(0)-202T(N), if any, accepted the cache data transfer request 218D(0)-218D(N).

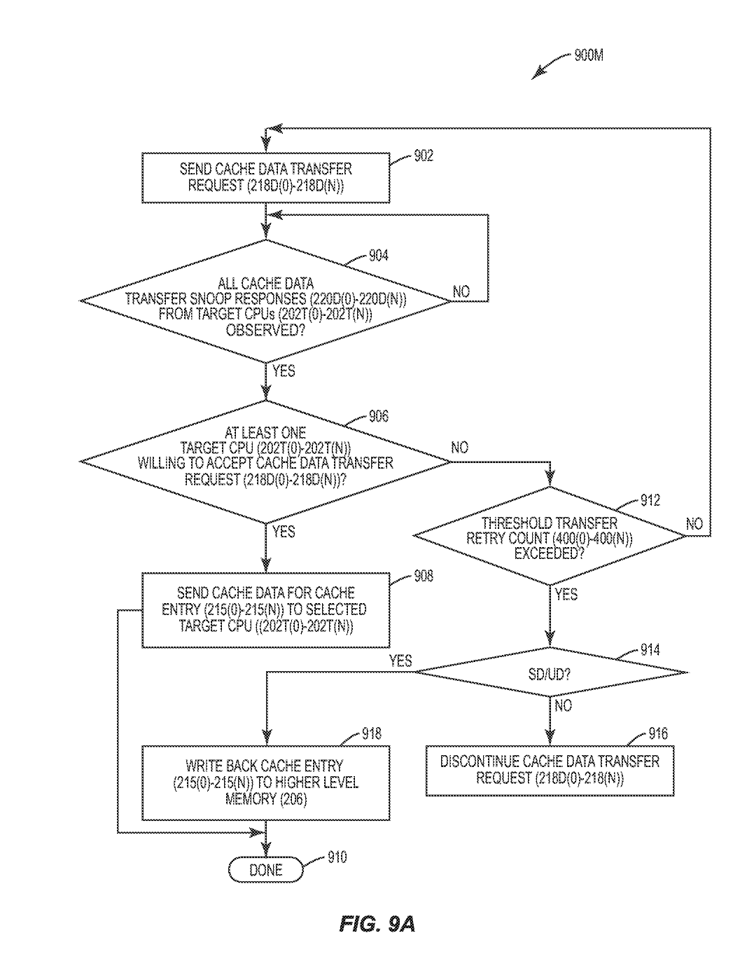

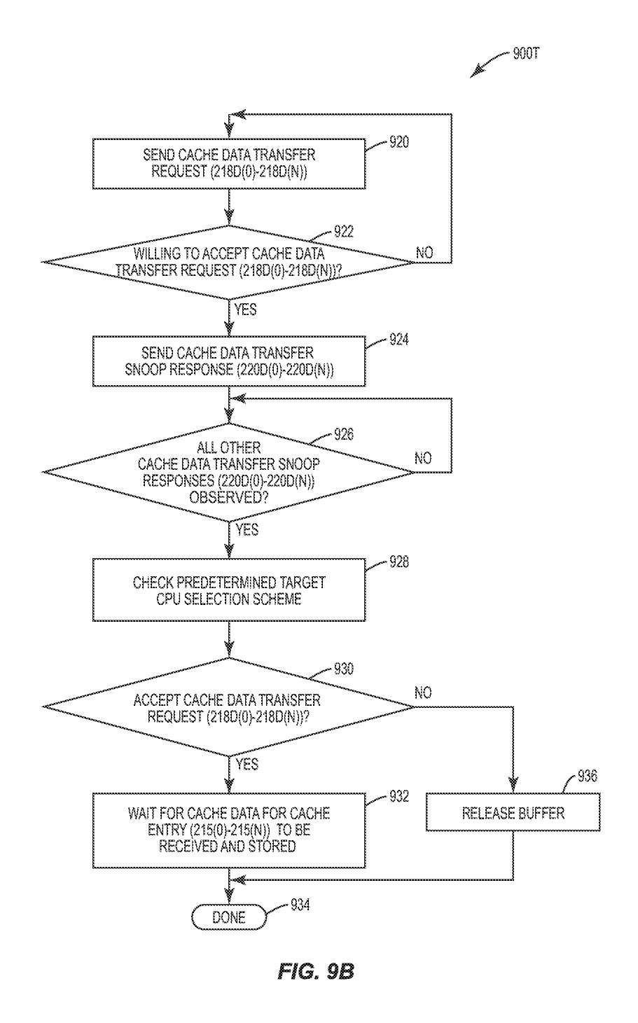

FIG. 9A is a flowchart illustrating an exemplary master CPU process 900M of a master CPU 202M(0)-202M(N) in the multi-processor system 200 in FIG. 8 issuing a respective cache data transfer request 218D(0)-218D(N) to other CPUs 202(0)-202(N) acting as target CPUs 202T(0)-202T(N). A CPU 202 among the plurality of CPUs 202(0)-202(N) that desires to perform a cache data transfer acts as a master CPU 202M(0)-202M(N). A respective master CPU 202M(0)-202M(N) issues a cache data transfer request 218D(0)-218D(N) for a respective cache entry 215(0)-215(N) in its associated respective local, shared cache memory 214(0)-214(N) on the shared communications bus 204 to be snooped by one or more target CPUs 202T(0)-202T(N) among the plurality of CPUs 202(0)-202(N) (block 902 in FIG. 9A). For example, a master CPU 202M(0)-202M(N) may desire to perform a cache data transfer in response to an eviction of cache data having an exclusive or unique cache state from its associated respective local, shared cache memory 214(0)-214(N).

The master CPU 202M(0)-202M(N) will then observe one or more cache data transfer snoop responses 220D(0)-220D(N) from one or more target CPUs 202T(0)-202T(N) in response to issuance of the cache data transfer request 218D(0)-218D(N) (block 904 in FIG. 9A). Each of the cache data transfer snoop responses 220D(0)-220D(N) indicate a respective target CPU's 202T(0)-202T(N) willingness to accept the cache data transfer request 218D(0)-218D(N). The master CPU 202M(0)-202M(N) then determines if at least one target CPU 202T(0)-202T(N) among the target CPUs 202T(0)-202T(N) indicated a willingness to accept the cache data transfer request 218D(0)-21D(N) based on the observed cache data transfer snoop responses 220D(0)-220D(N) from the target CPUs 202T(0)-202T(N) (block 906 in FIG. 9A). The format of the cache data transfer snoop responses 220D(0)-220D(N) may be like described above in FIG. 6. Thus, the master CPU 202M(0)-202M(N) is self-aware of target CPUs 202T(0)-202T(N) willing to accept the cache data transfer request 218D(0)-218D(N). If at least one target CPU 202T(0)-202T(N) indicated a willingness to accept the cache data transfer request 218D(0)-218D(N), the master CPU 202M(0)-202M(N) will send the cache data for the respective cache entry 215(0)-215(N) of the cache data transfer request 218D(0)-218D(N) to the selected target CPU 202T(0)-202T(N) (block 908 in FIG. 9A), and the process 900M is done (block 910 in FIG. 9A). The selected target CPU 202T(0)-202T(N) is determined based on the cache data transfer snoop responses 220D(0)-220D(N) and the pre-configured CPU target selection scheme is employed. For example, the pre-configured CPU target selection scheme may be any of the pre-configured CPU target selection schemes described above, including closest position to the master CPU 202M(0)-202M(N), which may be determined based on the pre-configured CPU position table 700 in FIG. 7.

With continuing reference to FIG. 9A, if in block 906, no observed cache data transfer snoop responses 220D(0)-220D(N) indicated a willingness of the target CPUs 202T(0)-202T(N) to accept the cache data transfer request 218D(0)-218D(N), the master CPU 202M(0)-202M(N) can choose to retry the cache data transfer request 218D(0)-218D(N). For example, the target CPUs 202T(0)-202T(N) may have a temporary performance or other issue that is preventing a willingness to accept the cache data transfer request 218D(0)-218D(N), but may be willing to accept the cache data transfer request 218D(0)-218D(N) at a later time during a retry. In this regard, in one example, the master CPU 202M(0)-202M(N) determines if a respective threshold transfer retry count 400(0)-400(N) is exceeded (block 912 in FIG. 9A). If not, the master CPU 202M(0)-202M(N) increments the respective threshold transfer retry count 400(0)-400(N) and reissues a next cache data transfer request 218D(0)-218D(N) for the cache entry 215(0)-215(N) to be snooped by the target CPUs 202T(0)-202T(N). Next cache data transfer snoop responses 220D(0)-220D(N) from the target CPUs 202T(0)-202T(N) indicating a willingness to accept the retried next cache data transfer request 218D(0)-218D(N) are observed (blocks 902-906 in FIG. 9A).

If however, the respective threshold transfer retry count 400(0)-400(N) is exceeded (block 912 in FIG. 9A), the master CPU 202M(0)-202M(N) determines if the respective cache entry 215(0)-215(N) for the cache data transfer request 218D(0)-218D(N) is dirty (block 914 in FIG. 9A). If the respective cache entry 215(0)-215(N) is in a dirty shared or dirty unique state, the master CPU 202M(0)-202M(N) writes the respective cache entry 215(0)-215(N) back to the higher level memory 206 through the memory controller 208 (block 918 in FIG. 9A), and the process 900M is done (block 910 in FIG. 9A). If, however, the respective cache entry 215(0)-215(N) is not in a dirty shared or dirty unique state, the master CPU 202M(0)-202M(N) discontinues the cache data transfer request 218D(0)-218D(N) (block 916 in FIG. 9A).

FIG. 9B is a flowchart illustrating an exemplary target CPU process 900T of a target CPU 202T(0)-202T(N) in the multi-processor system 200 in FIG. 8, acting as a snoop processor. The target CPUs 202T(0)-202T(N) are each configured to perform the target CPU process 900T in FIG. 9B in response to issuance of a respective cache data transfer request 218D(0)-218D(N) by a master CPU 202M(0)-202M(N) according to the master CPU process 900M in FIG. 9A. In this regard, the target CPUs 202T(0)-202T(N) snoop the cache data transfer request 218D(0)-218D(N) issued by the master CPU 202M(0)-202M(N) on the shared communications bus 204 (block 920 in FIG. 9B). The target CPUs 202T(0)-202T(N) determine their willingness to accept the respective cache data transfer request 218D(0)-218D(N) (block 922 in FIG. 9B). For example, a target CPU 202T(0)-202T(N) may determine whether to accept a cache data transfer request 218D(0)-218D(N) based on the current performance demands on the target CPU 202T(0)-202T(N) at the time that the cache data transfer request 218D(0)-218D(N) is received. In these examples, the target CPU 202T(0)-202T(N) uses its own criteria and rules to determine if the target CPU 202T(0)-202T(N) is willing to accept a cache data transfer request 218D(0)-218D(N).

The target CPUs 202T(0)-202T(N) then issues a cache data transfer snoop response 220D(0)-220D(N) on the shared communications bus 204 to be observed by the master CPU 202M(0)-202M(N) indicating the willingness of the target CPU 202M(0)-202M(N) to accept the respective cache data transfer request 218D(0)-218D(N) (block 924 in FIG. 9B). If the target CPUs 202T(0)-202T(N) is willing to accept the cache data transfer request 218D(0)-218D(N), the target CPU 202T(0)-202T(N) may reserve a buffer to store the received cache data of the cache entry 215(0)-215(N) for the cache data transfer request 218D(0)-218D(N). The target CPUs 202T(0)-202T(N) also observe the cache data transfer snoop responses 220D(0)-220D(N) from the other target CPUs 202T(0)-202T(N) indicating a willingness of those other target CPUs 202T(0)-202T(N) to accept the caches data transfer request 218D(0)-218D(N) (block 926 in FIG. 9B). Each target CPU 202T(0)-202T(N) then determines acceptance of the cache data transfer request 218D(0)-218D(N) (block 930 in FIG. 9B) based on the observed cache data transfer snoop responses 220D(0)-220D(N) from the other target CPUs 202T(0)-202T(N) and a predefined target CPU selection scheme (block 928 in FIG. 9B). If a target CPU 202T(0)-202T(N) accepts a cache data transfer request 218D(0)-218D(N), the target CPU 202T(0)-202T(N) will then wait for the cache data for the cache entry 215(0)-215(N) to be received from the master CPU 202M(0)-202M(N) to store in its associated respective local, shared cache memory 214(0)-214(N) (block 932 in FIG. 9B), and the process 900T is done (block 934 in FIG. 9B). If however, the target CPU 202T(0)-202T(N) does not accept the cache data transfer request 218D(0)-218D(N), the target CPU 202T(0)-202T(N) releases a buffer created to store the cache entry 215(0)-215(N) to be transferred (block 936 in FIG. 9B), and the process 900T is done (block 934 in FIG. 9B).

In one example, the target CPUs 202T(0)-202T(N) each have the same predefined target CPU selection scheme so that each target CPU 202T(0)-202T(N) will be “self-aware” of which target CPU 202T(0)-202T(N) will accept the cache data transfer request 218D(0)-218D(N). If only one target CPU 202T(0)-202T(N) indicates a willingness to accept a cache data transfer request 218D(0)-218D(N), then no decision is required as to which target CPU 202T(0)-202T(N) will accept. However, if more than one target CPU 202T(0)-202T(N) indicates a willingness to accept a cache data transfer request 218D(0)-218D(N), then the target CPU 202T(0)-202T(N) that indicate a willingness to accept the cache data transfer request 218D(0)-218D(N) employs a predefined target CPU selection scheme to determine if it will accept the cache data transfer request 218D(0)-218D(N). In this regard, the target CPUs 202T(0)-202T(N) will also be self-aware of which target CPU 202T(0)-202T(N) accepted the cache data transfer request 218D(0)-218D(N). The master CPU 202M(0)-202M(N) can employ the same predefined target CPU selection scheme to also be self-aware of which target CPU 202T(0)-202T(N) accepted the cache data transfer request 218D(0)-218D(N). Any of the predefined target CPU selection schemes described above can be employed for determining which target CPU 202T(0)-202T(N) will accept a cache data transfer request 218D(0)-218D(N).

As discussed above, the CPUs 202(0)-202(N) in the multi-processor system 200 in FIG. 2 can be configured to perform cache state transfers and cache data transfers. If a cache state transfer fails, a master CPU 202M(0)-202M(N) can then attempt a cache data transfer. In the examples discussed above, the master CPU 202M(0)-202M(N) issues a cache data transfer after a failed cache state transfer requires two transfer processes. It is also possible to combine a cache state transfer process and a cache data transfer process into one combined cache state/data transfer process for efficiency purposes.

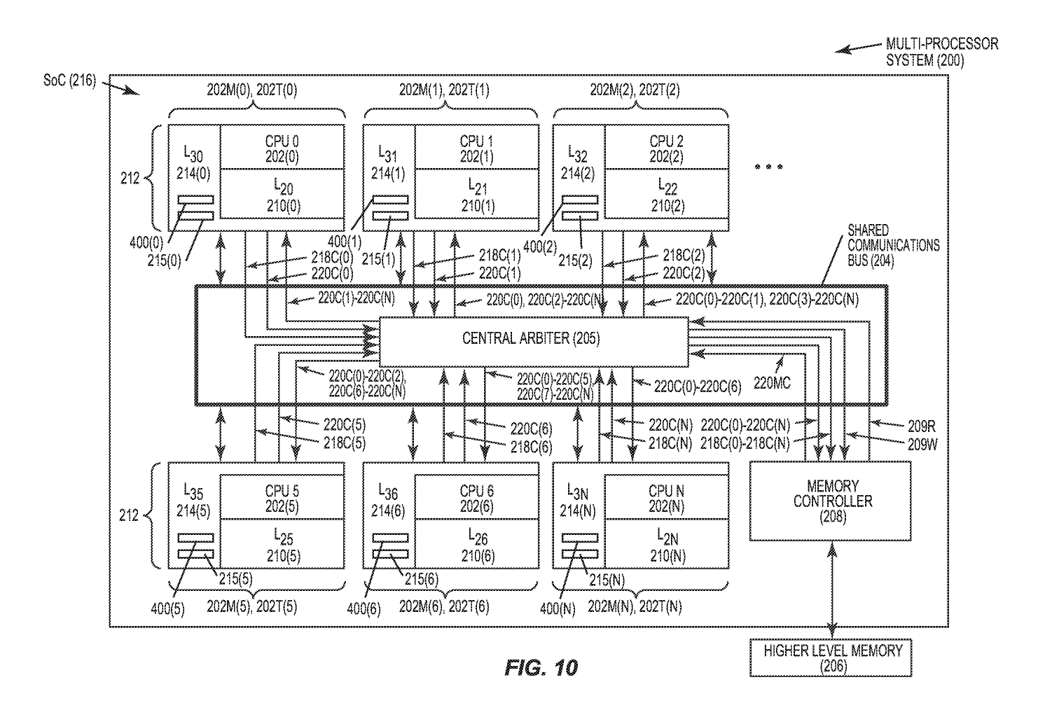

In this regard, FIG. 10 illustrates the multi-processor system 200 of FIG. 2 wherein a master CPU 202M(0)-202M(N) is configured to issue a respective combined cache state/data transfer request 218C(0)-218C(N) to other CPUs 202(0)-202(N) acting as target CPUs 202T(0)-202T(N). The cache state/data transfer request 218C(0)-218C(N) may be issued in response to a cache miss to a cache entry 215(0)-215(N) in an associated respective local, shared cache memory 214(0)-214(N) as an example, regardless of the cache state of the cache entry 215(0)-215(N). The cache miss to a cache entry 215(0)-215(N) in an associated respective local, shared cache memory 214(0)-214(N) may be preceded by a cache miss to a respective local, private cache memory 210(0)-210(N). The target CPUs 202T(0)-202T(N) will snoop the cache state/data transfer request 218C(0)-218C(N). The target CPUs 202T(0)-202T(N) will then determine their willingness to accept the cache state/data transfer request 218C(0)-218C(N) for the cache entry 215(0)-215(N) based on a predefined target CPU selection scheme. The target CPUs 202T(0)-202T(N) will then indicate their willingness to accept the cache state/data transfer request 218C(0)-218C(N) in their respective cache state/data transfer snoop responses 220C(0)-220C(N) that are provided to the master CPU 202M(0)-202M(N) and other target CPUs 202T(0)-202T(N). The master CPU 202M(0)-202M(N) and other target CPUs 202T(0)-202T(N) will be self-aware of which target CPU 202T(0)-202T(N), if any, accepted the cache state/data transfer request 218C(0)-218C(N).

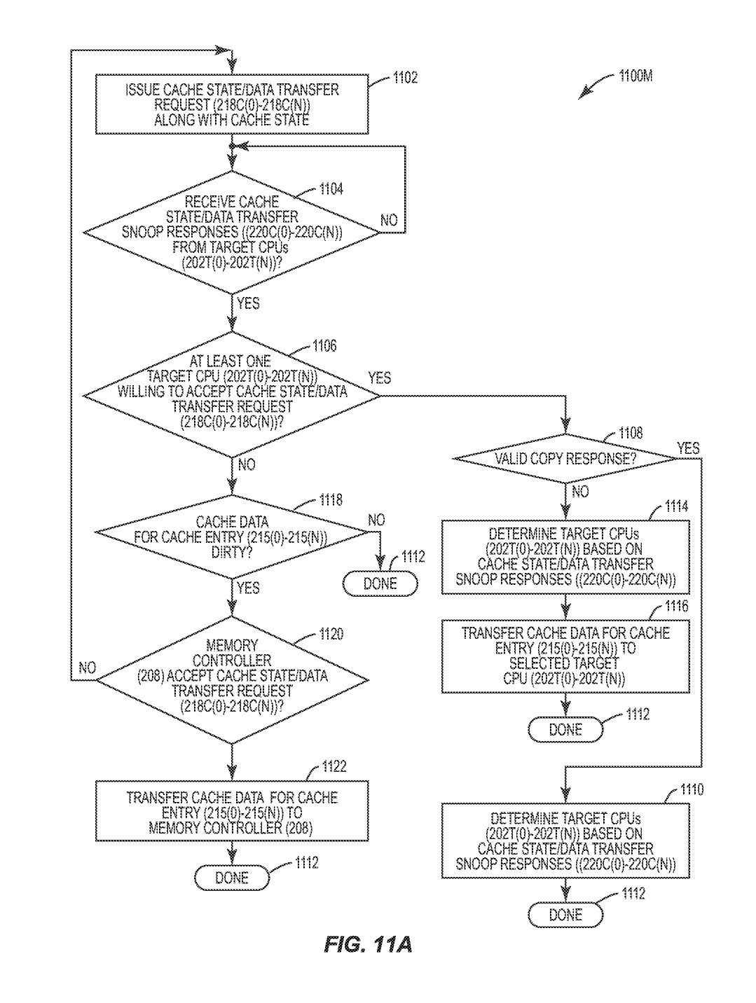

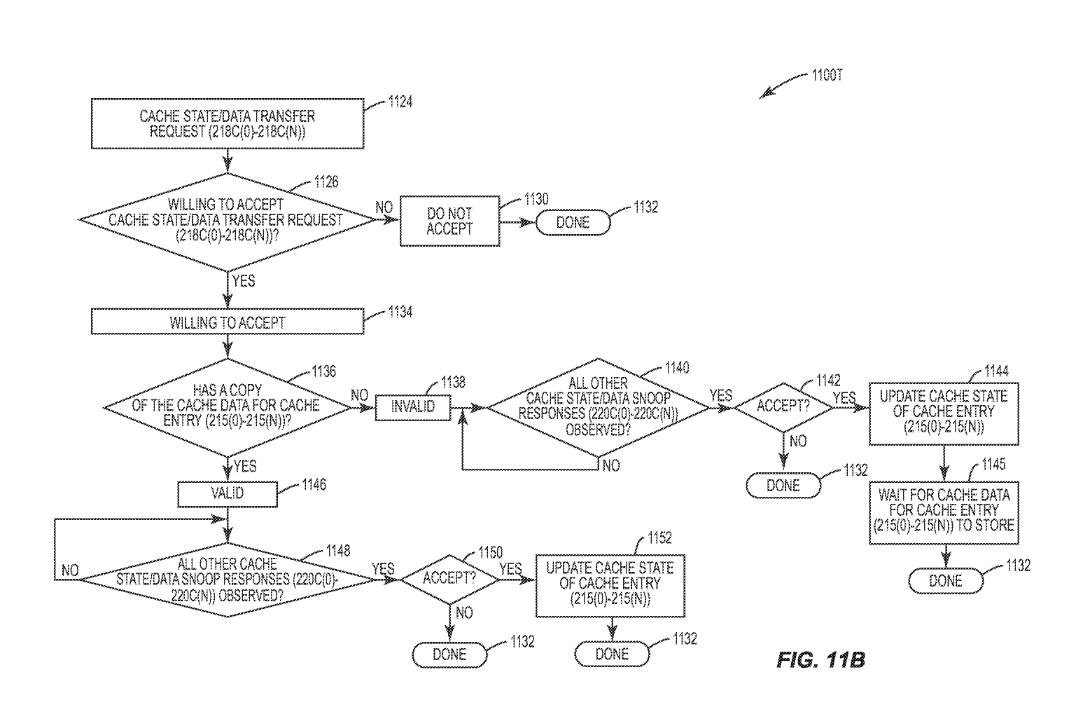

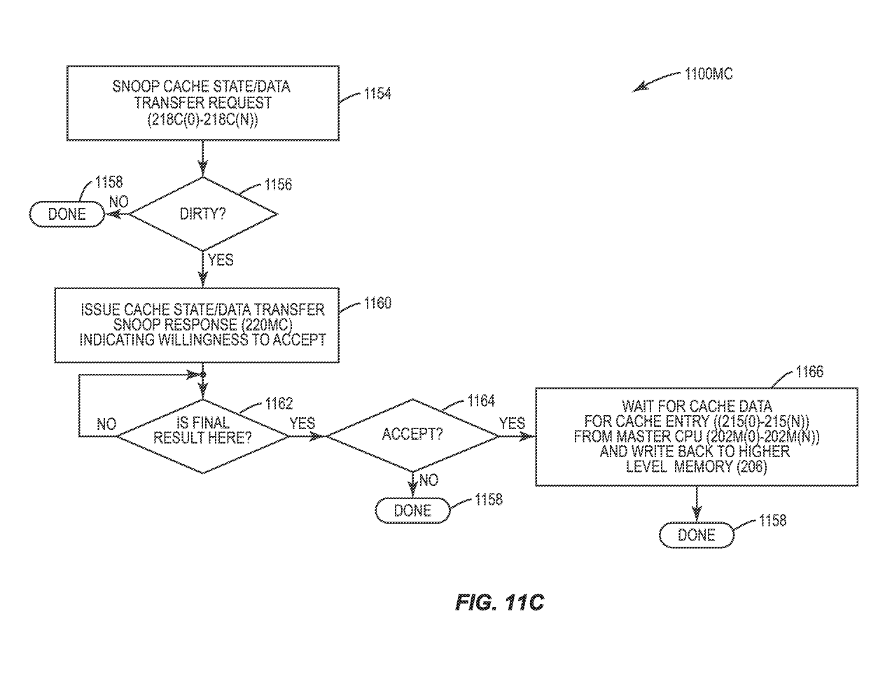

FIG. 11A is a flowchart illustrating an exemplary master CPU process 1100M of a master CPU 202M(0)-202M(N) in the multi-processor system 200 in FIG. 10 issuing a respective combined cache state/data transfer request 218C(0)-218C(N) to other CPUs 202(0)-202(N) acting as target CPUs 202T(0)-202T(N). A CPU 202 among the plurality of CPUs 202(0)-202(N) that desires to perform a cache state/data transfer acts as a master CPU 202M(0)-202M(N). A respective master CPU 202M(0)-202M(N) issues a cache state/data transfer request 218C(0)-218C(N) along with a cache state for a respective cache entry 215(0)-215(N) in its associated respective local, shared cache memory 214(0)-214(N) on the shared communications bus 204 to be snooped by one or more target CPUs 202T(0)-202T(N) among the plurality of CPUs 202(0)-202(N) (block 1102 in FIG. 11A).

The master CPU 202M(0)-202M(N) will then observe one or more cache state/data transfer snoop responses 220C(0)-220C(N) from one or more target CPUs 202T(0)-202T(N) in response to issuance of the cache state/data transfer request 218C(0)-218C(N) (block 1104 in FIG. 11A). Each of the cache state/data transfer snoop responses 220C(0)-220C(N) indicate a respective target CPU's 202T(0)-202T(N) willingness to accept the cache state/data transfer request 218C(0)-218C(N). The master CPU 202M(0)-202M(N) then determines if at least one target CPU 202T(0)-202T(N) among the target CPUs 202T(0)-202T(N) indicated a willingness to accept the cache state/data transfer request 218C(0)-218C(N) based on the observed cache state/data transfer snoop responses 220C(0)-220C(N) from the target CPUs 202T(0)-202T(N) (block 1106 in FIG. 11A). The format of the cache state/data transfer snoop responses 220C(0)-220C(N) may be like described above in FIG. 6. Thus, the master CPU 202M(0)-202M(N) is self-aware of target CPUs 202T(0)-202T(N) willing to accept the cache state/data transfer request 218C(0)-218C(N). If at least one target CPU 202T(0)-202T(N) indicated a willingness to accept the cache state/data transfer request 218C(0)-218C(N), the master CPU 202M(0)-202M(N) will determine if a valid indicator is set in any of the cache state/data transfer snoop responses 220C(0)-220C(N) (block 1108 in FIG. 11A). As will be discussed below, the target CPUs 202T(0)-202T(N) willing to accept the cache state/data transfer request 218C(0)-218C(N) will set a valid indicator in their respective cache state/data transfer snoop response 220C(0)-220C(N) indicating if a valid copy of the cache entry 215(0)-215(N) for the cache state/data transfer request 218C(0)-218C(N) is present in its associated respective local, shared cache memory 214(0)-214(N). If so, only a cache state transfer is required. The master CPU 202M(0)-202M(N) determines the selected target CPU 202T(0)-202T(N) to accept the cache state/data transfer request 218C(0)-218C(N) (block 1110 in FIG. 11A), and the process 1100M is done (block 1112 in FIG. 11A).

With continuing reference to FIG. 11A, if in block 1108, the master CPU 202M(0)-202M(N) determined that a valid indicator was not set in any of the cache state/data transfer snoop responses 220C(0)-220C(N) (block 1108 in FIG. 11A), a cache state transfer cannot be performed to execute the cache state/data transfer request 218C(0)-218C(N). A cache data transfer is required. In this regard, the master CPU 202M(0)-202M(N) determines the selected target CPU 202T(0)-202T(N) to accept the cache state/data transfer request 220C(0)-220C(N) based on a predefined target CPU selection scheme (block 1114 in FIG. 11A). The predefined target CPU selection scheme can be any of the predefined target CPU selection schemes described above previously. The master CPU 202M(0)-202M(N) sends the cache data for the cache entry 215(0)-215(N) to be transferred to the selected target CPU 202T(0)-202T(N) (block 1116 in FIG. 11A), and the process 1100M is done (block 1112 in FIG. 11A).

With continuing reference to FIG. 11A, if in block 1106, no target CPUs 202T(0)-202T(N) indicated a willingness to accept the cache state/data transfer request 218C(0)-218C(N), the master CPU 202M(0)-202M(N) determines if the cache data for the respective cache entry 215(0)-215(N) for the cache state/data transfer request 218C(0)-218C(N) is dirty (block 1118). If not, the process 1100M is done (block 1112 in FIG. 11A), as the cache data does not have to be transferred to make room for storing evicted cache data in the associated respective local, shared cache memory 214(0)-214(N). If however, the cache data for the respective cache entry 215(0)-215(N) for the cache state/data transfer request 218C(0)-218C(N) is dirty (block 1118), the master CPU 202M(0)-202M(N) determines if the memory controller 208 will accept the cache state/data transfer request 218C(0)-218C(N) based on a cache state/data transfer snoop response 220C(0)-220C(N) from the memory controller 208 (block 1120 in FIG. 11A). As discussed above, the memory controller 208 can be configured to snoop cache transfer requests on the shared communications bus 204 like a target CPU 202T(0)-202T(N). If the memory controller 208 can accept the cache state/data transfer request 218C(0)-218C(N), master CPU 202M(0)-202M(N) transfers the cache data for the cache entry 215(0)-215(N) to the selected target CPU 202T(0)-202T(N) to the memory controller 208 (block 1122 in FIG. 11A), and the process 1100M is done (block 1112 in FIG. 11A). If the memory controller 208 cannot accept the cache state/data transfer request 218C(0)-218C(N), the process 1100M returns to block 1102 to reissue the cache state/data transfer request 218C(0)-218C(N). Note that in one example, the memory controller 208 may be configured to always accept the cache state/data transfer request 218C(0)-218C(N) to avoid a situation where the cache state/data transfer request 218C(0)-218C(N) may not be written back to the higher level memory 206.

FIG. 11B is a flowchart illustrating an exemplary target CPU process 1100T of a target CPU 202T(0)-202T(N) in the multi-processor system 200 in FIG. 10, acting as a snoop processor. The target CPUs 202T(0)-202T(N) are each configured to perform the target CPU process 1100T in FIG. 11B in response to issuance of a respective cache state/data transfer request 218C(0)-218C(N) by a master CPU 202M(0)-202M(N) according to the master CPU process 1100M in FIG. 11A. In this regard, the target CPUs 202T(0)-202T(N) snoop the cache state/data transfer request 218C(0)-218C(N) issued by the master CPU 202M(0)-202M(N) on the shared communications bus 204 (block 1124 in FIG. 11B). The target CPUs 202T(0)-202T(N) determine their willingness to accept the respective cache data transfer request 218C(0)-218C(N) (block 1126 in FIG. 11B). For example, a target CPU 202T(0)-202T(N) may determine whether to accept a cache state/data transfer request 218C(0)-218C(N) based on the current performance demands on the target CPU 202T(0)-202T(N) at the time that the cache state/data transfer request 218C(0)-218C(N) is received. In these examples, the target CPU 202T(0)-202T(N) uses its own criteria and rules to determine if the target CPU 202T(0)-202T(N) is willing to accept a cache state/data transfer request 218C(0)-218C(N). If the target CPU 202T(0)-202T(N) cannot accept the cache state/data transfer request 218C(0)-218C(N), the target CPU 202T(0)-202T(N) issues a cache state/data transfer snoop response 220C(0)-220C(N) on the shared communications bus 204 to be received by the master CPU 202M(0)-202M(N) indicating a non-willingness of the target CPU 202M(0)-202M(N) to accept the respective cache state/data transfer request 218C(0)-218C(N) (block 1130 in FIG. 11B), and the process 1100T is done (block 1132 in FIG. 11B). For example, the target CPU 202T(0)-202T(N) can drive its assigned bit in the cache state/data transfer snoop response 220C(0)-220C(N) to indicate non-acceptance, as discussed by example in FIG. 6 above.

With continuing reference to FIG. 11B, if the target CPU 202T(0)-202T(N) is willingness to accept the respective cache state/data transfer request 218C(0)-218C(N), the target CPU 202T(0)-202T(N) issues a cache state/data transfer snoop response 220C(0)-220C(N) on the shared communications bus 204 to be observed by the master CPU 202M(0)-202M(N) indicating a willingness of the target CPU 202T(0)-202T(N) to accept the respective cache state/data transfer request 218C(0)-218C(N) (block 1134 in FIG. 11B). The target CPU 202T(0)-202T(N) sets a validity indicator in the issued cache state/data transfer snoop response 220C(0)-220C(N) indicating if its associated respective local, shared cache memory 214(0)-214(N) has a copy of the cache data for the cache entry 215(0)-215(N) (block 1136 in FIG. 11B). If the target CPU 202T(0)-202T(N) does not have a copy of the cache data for the cache entry 215(0)-215(N) (i.e., invalid), the target CPU 202T(0)-202T(N) provides an invalid indicator in its cache state/data transfer snoop response 220C(0)-220C(N) (block 1138 in FIG. 11B). This means that a cache data transfer is needed. The target CPU 202T(0)-202T(N) then waits until all of the other cache state/data transfer snoop responses 220C(0)-220C(N) from the other target CPUs 202T(0)-202T(N) have been received (block 1140 in FIG. 11B). The target CPU 202T(0)-202T(N) then determines if it is the designated recipient of the cache state/data transfer request 218C(0)-218C(N) based on the predefined target CPU selection scheme (block 1142 in FIG. 11B). If not, the process 1100T is done without the cache entry 215(0)-215(N) for the target CPU 202T(0)-202T(N) being updated (block 1132 in FIG. 11B). If however, the target CPU 202T(0)-202T(N) is determined to be the recipient of the cache state/data transfer request 218C(0)-218C(N) based on the predefined target CPU selection scheme (block 1142), the target CPU 202T(0)-202T(N) receives the cache state of the cache data for the cache entry 215(0)-215(N) to be transferred (block 1144 in FIG. 11B), and receives the cache data from the master CPU 202M(0)-202M(N) to be stored in its associated respective local, shared cache memory 214(0)-214(N) (block 1145 in FIG. 11B).

With continuing reference to FIG. 11B, if the local, shared cache memory 214(0)-214(N) for the target CPU 202T(0)-202T(N) has a copy of the cache data for the cache entry 215(0)-215(N) for the cache state/data transfer request 218C(0)-218C(N) in block 1136, the target CPU 202T(0)-202T(N) provides an valid indicator in its cache state/data transfer snoop response 220C(0)-220C(N) (block 1146 in FIG. 11B). This means that only a cache state transfer is needed. The target CPU 202T(0)-202T(N) waits until all of the other cache state/data transfer snoop responses 220C(0)-220C(N) from the other target CPUs 202T(0)-202T(N) have been observed (block 1148 in FIG. 11B). The target CPU 202T(0)-202T(N) then determines if it accepts the cache state/data transfer request 218C(0)-218C(N) based on the predefined target CPU selection scheme (block 1150 in FIG. 11B). If not, the process 1100T is done without a state transfer of the cache data for the cache entry 215(0)-215(N) to a target CPU 202T(0)-202T(N) (block 1132 in FIG. 11B). If the target CPU 202T(0)-202T(N) accepts the cache state/data transfer request 218C(0)-218C(N) based on the predefined target CPU selection scheme (block 1142), the target CPU 202T(0)-202T(N) receives the cache state for the cache entry 215(0)-215(N) to be transferred (block 1152 in FIG. 11B), and updates the cache state of the copy of the cache entry 215(0)-215(N) for the cache state/data transfer request 218C(0)-218C(N) in its associated respective local, shared cache memory 214(0)-214(N) (block 1152 in FIG. 11B), and the process 1100T is done (block 1132).

FIG. 11C is a flowchart illustrating an optional exemplary memory controller process 1100MC of the memory controller 208 in FIG. 2, acting as a snoop processor, like target CPUs 202T(0)-202T(N). As discussed above, the memory controller 208 can be configured to also snoop the combined cache state/data transfer request 218C(0)-218C(N) issued by a master CPU 202M(0)-202M(N). If no other target CPUs 202T(0)-202T(N) accept a cache state/data transfer request 218C(0)-218C(N), the memory controller 208 can accept the cache state/data transfer request 218C(0)-218C(N). A cache state/data transfer snoop response 220MC issued by the memory controller 208 can be used by the master CPU 202M(0)-202M(N) to know that the memory controller 208 accepted the cache state/data transfer request 218C(0)-218C(N). Providing for the memory controller 208 to act like a snoop processor allows a cache state/data transfer request 218C(0)-218C(N) to be handled in one transfer process if no other target CPUs 202T(0)-202T(N) accept a cache state/data transfer request 218C(0)-218C(N).

In this regard, the memory controller 208 snoops the cache state/data transfer request 218C(0)-218C(N) issued by the master CPU 202M(0)-202M(N) on the shared communications bus 204 (block 1154 in FIG. 11C). The memory controller 208 determines if the cache data for the cache entry 215(0)-215(N) for the cache state/data transfer request 218C(0)-218C(N) is dirty (block 1156 in FIG. 11C). If not, the process 1100MC is done since the cache data for the cache entry 215(0)-215(N) does not have to be written back to the higher level memory 206 (block 1158 in FIG. 11C). If cache data for the cache entry 215(0)-215(N) for the cache state/data transfer request 218C(0)-218C(N) is dirty, the memory controller 208 issues a cache state/data transfer snoop response 220MC indicating a willingness to accept the cache state/data transfer request 218C(0)-218C(N) (block 1160 in FIG. 11C). The target CPU 202T(0)-202T(N) waits until all of the other cache state/data transfer snoop responses 220C(0)-220C(N) from the other target CPUs 202T(0)-202T(N) have been received (block 1162 in FIG. 11C). Thereafter, the memory controller 208 determines if it accepts the cache state/data transfer request 218C(0)-218C(N) based on the other cache state/data transfer snoop responses 220C(0)-220C(N) from the other target CPUs 202T(0)-202T(N) and the predefined target CPU selection scheme (block 1164 in FIG. 11C). For example, the memory controller 208 may be configured to not accept the cache state/data transfer request 218C(0)-218C(N) if any other target CPUs 202T(0)-202T(N) accepts the cache state/data transfer request 218C(0)-218C(N). If the memory controller 208 determines that the target CPU 202T(0)-202T(N) accepts the cache state/data transfer request 218C(0)-218C(N) (i.e., the cache data is dirty), the process 1100MC is done without a transfer since another target CPU 202T(0)-202T(N) accepted the transfer (block 1158 in FIG. 11C). If however, the cache state/data transfer request 218C(0)-218C(N) is not accepted by any target CPU 202T(0)-202T(N), the memory controller 208 receives the cache data from the master CPU 202M(0)-202M(N) to be stored in its associated respective local, shared cache memory 214(0)-214(N) (block 1166 in FIG. 11C), and the process 1100MC is done (block 1158 in FIG. 11C).

A multi-processor system having a plurality of CPUs, wherein one or more of the CPUs acting as a master CPU is configured to issue a cache transfer request to other target CPUs configured to receive the cache transfer request and self-determine acceptance of the requested cache transfer based on a predefined target CPU selection scheme, including without limitation the multi-processor systems in FIGS. 2, 4, and 8, may be provided in or integrated into any processor-based device. Examples, without limitation, include a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

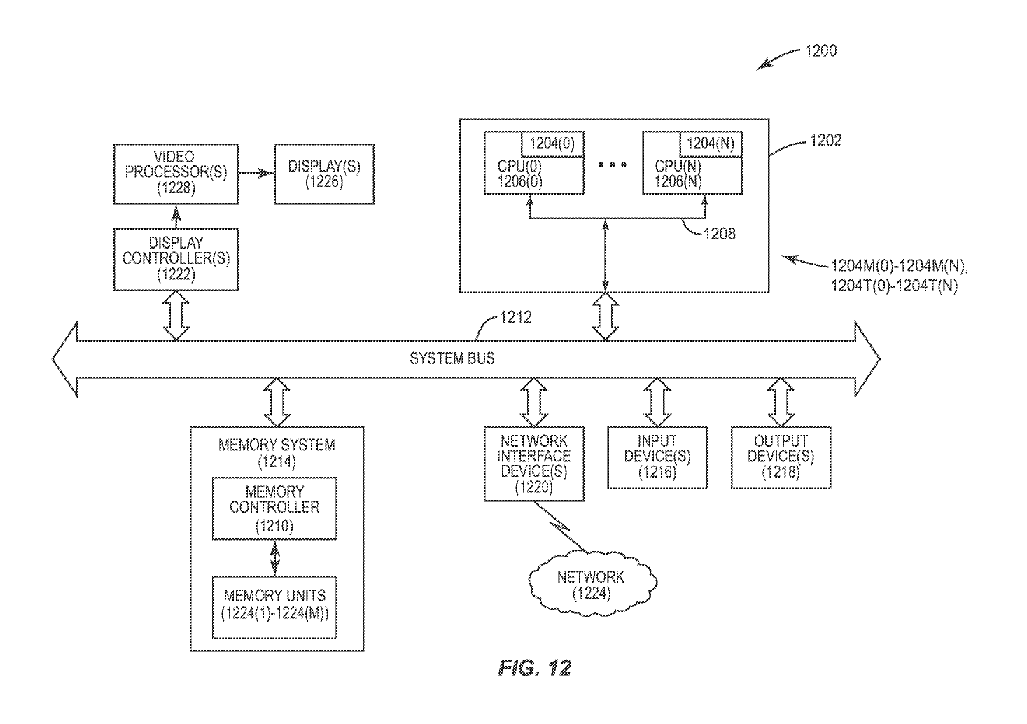

In this regard, FIG. 12 illustrates an example of a processor-based system 1200 that includes a multi-processor system 1202. In this example, the multi-processor system 1202 includes a processor 1204(0)-1204(N) that includes a plurality of CPUs 1204(0)-1204(N). One or more of the CPUs 1204(0)-1204(N), acting as a master CPU 1204M(0)-1204M(N), is configured to issue a cache transfer request to other target CPUs 1204T(0)-1204T(N) acting as snoop processors, as described above. For example, CPUs 1204 (0)-1204 (N) acting as master CPUs 1204M(0)-1204(M)(N) could be the CPU 202M(1)-202M(N) in FIGS. 2, 4, and 8 as examples. The target CPUs 1204T(0)-1204T(N) are configured to receive the cache data transfer and self-determine acceptance of the requested cache data transfer based on a predefined target CPU selection scheme. Local, shared cache memories 1206(0)-1206(N) are associated with a respective CPU 1204(0)-1204(N) to provide local cache memory, but which can be shared about the other CPUs 1204(0)-1204(N) over a shared communications bus 1208. For example, CPUs 1204 (0)-1204 (N) acting as target CPUs 1204T(0)-1204T(N) could be the CPU 202T(0)-202T(N) in FIGS. 2, 4, and 8 as examples. The CPUs 1204(0)-1204(N) can issue memory access commands over the shared communications bus 1208 to go out over a system bus 1212. Memory access requests issued by the CPUs 1204(0)-1204(N) go out over the system bus 1212 to a memory controller 1210 in the memory system 1214. Although not illustrated in FIG. 12, multiple system buses 1212 could be provided, wherein each system bus 1212 constitutes a different fabric. For example, the processor 1204(0)-1204(N) can communicate bus transaction requests to a memory system 1214 as an example of a slave device.

Other master and slave devices can be connected to the system bus 1212. As illustrated in FIG. 12, these devices can include the memory system 1214, one or more input devices 1216, one or more output devices 1218, one or more network interface devices 1220, and one or more display controllers 1222. The input device(s) 1216 can include any type of input device, including but not limited to input keys, switches, voice processors, etc. The output device(s) 1218 can include any type of output device, including but not limited to audio, video, other visual indicators, etc. The network interface device(s) 1220 can be any devices configured to allow exchange of data to and from a network 1224. The network 1224 can be any type of network, including but not limited to a wired or wireless network, a private or public network, a local area network (LAN), a wireless local area network (WLAN), a wide area network (WAN), a BLUETOOTH™ network, and the Internet. The network interface device(s) 1220 can be configured to support any type of communications protocol desired.

The processor 1204(0)-1204(N) may also be configured to access the display controller(s) 1222 over the system bus 1212 to control information sent to one or more displays 1226. The display controller(s) 1222 sends information to the display(s) 1226 to be displayed via one or more video processors 1228, which process the information to be displayed into a format suitable for the display(s) 1226. The display(s) 1226 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A multi-processor system, comprising:
a shared communications bus;
a plurality of central processing units (CPUs) communicatively coupled to the shared communications bus, wherein at least two CPUs among the plurality of CPUs are each associated with a local, shared cache memory configured to store cache data; and
a master CPU among the plurality of CPUs configured to:
issue a cache transfer request for a cache entry in its associated respective local, shared cache memory, on the shared communications bus to be snooped by one or more target CPUs among the plurality of CPUs;
observe one or more cache transfer snoop responses from the one or more target CPUs in response to issuance of the cache transfer request, each of the one or more cache transfer snoop responses indicating a respective target CPU's willingness to accept the cache transfer request; and
determine if at least one target CPU among the one or more target CPUs indicated a willingness to accept the cache transfer request based on the observed one or more cache transfer snoop responses.

2. The multi-processor system of claim 1, wherein:
the one or more cache transfer snoop responses from the one or more target CPUs each comprise a snoop response tag field comprising a plurality of bits each uniquely assigned to a CPU among the plurality of CPUs; and
the master CPU configured to:
determine the willingness of the at least one target CPU among the one or more target CPUs to accept the cache transfer request based on bit values in the plurality of bits in the snoop response tag field in the one or more cache transfer snoop responses.

3. The multi-processor system of claim 1, further comprising a memory controller communicatively coupled to the shared communications bus, the memory controller configured to access a higher level memory.

4. The multi-processor system of claim 3, wherein in response to none of the observed one or more cache transfer snoop responses indicating a willingness of a target CPU to accept the cache transfer request, the master CPU is further configured to issue the cache transfer request for the cache entry to the memory controller.

5. The multi-processor system of claim 3, wherein the master CPU among the plurality of CPUs is further configured to issue the cache transfer request on the shared communications bus to be snooped by the memory controller.

6. The multi-processor system of claim 1, wherein a target CPU among the one or more target CPUs is configured to:
receive the cache transfer request on the shared communications bus from the master CPU;
determine a willingness to accept the cache transfer request;
issue a cache transfer snoop response of the one or more cache transfer snoop responses on the shared communications bus to be received by the master CPU indicating the willingness of the target CPU to accept the cache transfer request;
observe the one or more cache transfer snoop responses from other target CPUs among the one or more target CPUs indicating a willingness to accept the cache transfer request in response to issuance of the cache transfer request by the master CPU; and
determine acceptance of the cache transfer request based on the observed one or more cache transfer snoop responses from the other target CPUs and a predefined target CPU selection scheme.

7. The multi-processor system of claim 6, wherein, in response to at least one of the observed one or more cache transfer snoop responses from the other target CPUs indicating the willingness to accept the cache transfer request, the target CPU is configured to determine acceptance of the cache transfer request based on the predefined target CPU selection scheme comprising selection of the target CPU closest to the master CPU willing to accept the cache transfer request based on the observed one or more cache transfer snoop responses.

8. The multi-processor system of claim 7, wherein the target CPU is configured to determine the target CPU closest to the master CPU willing to accept the cache transfer request based on a pre-configured CPU position table.

9. The multi-processor system of claim 6, wherein, in response to none of the observed one or more cache transfer snoop responses from the other target CPUs indicating the willingness to accept the cache transfer request, the target CPU is configured to accept the cache transfer request based on the predefined target CPU selection scheme comprising selection of an only target CPU willing to accept the cache transfer request.

10. The multi-processor system of claim 1, wherein the master CPU is configured to:
determine a cache state of the cache entry in the associated respective local, shared cache memory; and
in response to the cache state of the cache entry being a shared cache state:
issue the cache transfer request comprising a cache state transfer request for the cache entry in the shared cache state in its associated respective local, shared cache memory on the shared communications bus to be snooped by the one or more target CPUs;
observe the one or more cache transfer snoop responses comprising one or more cache state transfer snoop responses from the one or more target CPUs in response to issuance of the cache state transfer request, each of the one or more cache state transfer snoop responses indicating a respective target CPU's willingness to accept the cache state transfer request; and
determine if at least one target CPU among the one or more target CPUs indicated a willingness to accept the cache state transfer request based on the observed one or more cache state transfer snoop responses.

11. The multi-processor system of claim 10, wherein the master CPU is further configured to, in response to determining the at least one target CPU among the one or more target CPUs indicated the willingness to accept the cache state transfer request, update the cache state for the cache entry in the associated respective local, shared cache memory.

12. The multi-processor system of claim 10, wherein, in response to determining that no target CPUs among the one or more target CPUs indicated a willingness to accept the cache state transfer request, the master CPU is further configured to:
issue a next cache state transfer request for the cache entry in the shared cache state in its associated respective local, shared cache memory on the shared communications bus to be snooped by the one or more target CPUs;
observe one or more next cache state transfer snoop responses from the one or more target CPUs among the plurality of CPUs in response to issuance of the next cache state transfer request, each of the one or more next cache state transfer snoop responses indicating a respective target CPU's willingness to accept the next cache state transfer request; and
determine if at least one target CPU among the one or more target CPUs indicated a willingness to accept the next cache state transfer request based on the observed one or more next cache state transfer snoop responses.

13. The multi-processor system of claim 12, wherein, in response to determining that no target CPUs among the one or more target CPUs indicated a willingness to accept the cache state transfer request, the master CPU is further configured to:
update a threshold transfer retry count;
determine if the threshold transfer retry count exceeds a predetermined state transfer retry count; and
in response to the threshold transfer retry count not exceeding the predetermined state transfer retry count:
issue the next cache state transfer request for the cache entry in the shared cache state in its associated respective local, shared cache memory on the shared communications bus to be snooped by the one or more target CPUs;
observe the one or more next cache state transfer snoop responses from the one or more target CPUs among the plurality of CPUs in response to issuance of the next cache state transfer request, each of the one or more next cache state transfer snoop responses indicating the respective target CPU's willingness to accept the next cache state transfer request; and
determine if the at least one target CPU among the one or more target CPUs indicated the willingness to accept the next cache state transfer request based on the observed one or more next cache state transfer snoop responses.

14. The multi-processor system of claim 13, wherein, in response to the threshold transfer retry count exceeding the predetermined state transfer retry count, the master CPU is further configured to:
issue the cache transfer request comprising a cache data transfer request for the cache entry in the shared cache state in its associated respective local, shared cache memory on the shared communications bus to be snooped by the one or more target CPUs;
observe the one or more cache transfer snoop responses comprising one or more cache data transfer snoop responses from the one or more target CPUs in response to issuance of the cache data transfer request, each of the one or more cache data transfer snoop responses indicating a respective target CPU's willingness to accept the cache data transfer request; and
determine if at least one target CPU among the one or more target CPUs indicated a willingness to accept the cache data transfer request based on the observed one or more cache data transfer snoop responses.

15. The multi-processor system of claim 10, wherein, in response to the master CPU determining that no target CPUs among the one or more target CPUs indicated a willingness to accept the cache state transfer request, the master CPU is further configured to:
issue the cache transfer request comprising a cache data transfer request for the cache entry in the shared cache state in its associated respective local, shared cache memory on the shared communications bus to be snooped by the one or more target CPUs;
observe the one or more cache transfer snoop responses comprising one or more cache data transfer snoop responses from the one or more target CPUs in response to issuance of the cache data transfer request, each of the one or more cache data transfer snoop responses indicating a respective target CPU's willingness to accept the cache data transfer request; and
determine if at least one target CPU among the one or more target CPUs indicated a willingness to accept the cache data transfer request based on the observed one or more cache data transfer snoop responses.

16. The multi-processor system of claim 10, wherein a target CPU among the one or more target CPUs is configured to:
receive the cache state transfer request on the shared communications bus from the master CPU;
determine a willingness to accept the cache state transfer request;
issue a cache state transfer snoop response of the one or more cache state transfer snoop responses on the shared communications bus to be received by the master CPU indicating the willingness of the target CPU to accept the cache state transfer request;
observe the one or more cache state transfer snoop responses from other target CPUs among the one or more target CPUs indicating a willingness to accept the cache state transfer request in response to issuance of the cache state transfer request by the master CPU; and
determine acceptance of the cache state transfer request based on the observed one or more cache state transfer snoop responses from the other target CPUs and a predefined target CPU selection scheme.

17. The multi-processor system of claim 16, wherein, in response to at least one of the observed one or more cache state transfer snoop responses from the other target CPUs indicating the willingness to accept the cache state transfer request, the target CPU is configured to determine acceptance of the cache state transfer request based on the predefined target CPU selection scheme comprising selection of the target CPU closest to the master CPU willing to accept the cache state transfer request based on the observed one or more cache state transfer snoop responses.

18. The multi-processor system of claim 17, wherein the target CPU is configured to determine the target CPU closest to the master CPU willing to accept the cache state transfer request based on a pre-configured CPU position table.

19. The multi-processor system of claim 16, wherein, in response to none of the observed one or more cache state transfer snoop responses from the other target CPUs indicating the willingness to accept the cache state transfer request, the target CPU is configured to accept the cache state transfer request based on the predefined target CPU selection scheme comprising selection of an only target CPU willing to accept the cache state transfer request.

20. The multi-processor system of claim 1, wherein the master CPU is further configured to determine a cache state of the cache entry in its associated respective local, shared cache memory; and
in response to the cache state of the cache entry being an exclusive cache state, the master CPU is configured to:
issue the cache transfer request comprising a cache data transfer request for the cache entry in the exclusive cache state in its associated respective local, shared cache memory on the shared communications bus to be snooped by the one or more target CPUs;
observe the one or more cache transfer snoop responses comprising one or more cache data transfer snoop responses from the one or more target CPUs in response to issuance of the cache data transfer request, each of the one or more cache data transfer snoop responses indicating a respective target CPU's willingness to accept the cache data transfer request; and
determine if at least one target CPU among the one or more target CPUs indicated a willingness to accept the cache data transfer request based on the observed one or more cache data transfer snoop responses.

21. The multi-processor system of claim 20, wherein the master CPU is configured to, in response to determining the at least one target CPU among the one or more target CPUs indicated the willingness to accept the cache data transfer request:
determine a selected target CPU among the at least one target CPU for accepting the cache data transfer request based on the observed one or more cache data transfer snoop responses from other target CPUs and a predefined target CPU selection scheme; and
issue a cache data transfer comprising the cache data for the cache entry on the shared communications bus to the selected target CPU.

22. The multi-processor system of claim 20, wherein, in response to determining that no target CPUs among the one or more target CPUs indicated a willingness to accept the cache data transfer request, the master CPU is further configured to:
issue a next cache data transfer request for the cache entry in the exclusive cache state in its associated respective local, shared cache memory on the shared communications bus to be snooped by the one or more target CPUs;
observe one or more next cache data transfer snoop responses from the one or more target CPUs among the plurality of CPUs in response to issuance of the next cache data transfer request, each of the one or more next cache data transfer snoop responses indicating a respective target CPU's willingness to accept the next cache data transfer request; and
determine if at least one target CPU among the one or more target CPUs indicated a willingness to accept the next cache data transfer request based on the observed one or more next cache data transfer snoop responses.

23. The multi-processor system of claim 22, wherein, in response to determining that no target CPUs among the one or more target CPUs indicated a willingness to accept the cache data transfer request, the master CPU is further configured to:
update a threshold transfer retry count;
determine if the threshold transfer retry count exceeds a predetermined data transfer retry count; and
in response to the threshold transfer retry count not exceeding the predetermined data transfer retry count:
issue the next cache data transfer request for the cache entry in the exclusive cache state in its associated respective local, shared cache memory on the shared communications bus to be snooped by the one or more target CPUs;
observe the one or more next cache data transfer snoop responses from the one or more target CPUs among the plurality of CPUs in response to issuance of the next cache data transfer request, each of the one or more next cache data transfer snoop responses indicating the respective target CPU's willingness to accept the next cache data transfer request; and
determine if the at least one target CPU among the one or more target CPUs indicated the willingness to accept the next cache data transfer request based on the observed one or more next cache data transfer snoop responses.

24. The multi-processor system of claim 23, wherein, in response to the threshold transfer retry count exceeding the predetermined data transfer retry count, the master CPU is further configured to:
determine if the cache data for the cache entry is dirty; and
in response to the cache data for the cache entry being dirty, write back the cache data over the shared communications bus to a memory controller communicatively coupled to the shared communications bus, the memory controller configured to access a higher level memory.

25. The multi-processor system of claim 24, wherein, in response to the cache data for the cache entry not being dirty, the master CPU is configured to discontinue the cache data transfer request.

26. The multi-processor system of claim 20, wherein a target CPU among the one or more target CPUs is configured to:
receive the cache data transfer request on the shared communications bus from the master CPU;
determine a willingness to accept the cache data transfer request;
issue a cache data transfer snoop response on the shared communications bus to be received by the master CPU indicating the willingness of the target CPU to accept the cache data transfer request;
observe the one or more cache data transfer snoop responses from other target CPUs among the one or more target CPUs indicating a willingness to accept the cache data transfer request in response to issuance of the cache data transfer request by the master CPU; and
determine if the target CPU will accept the cache data transfer request based on the observed one or more cache data transfer snoop responses from the other target CPUs and a predefined target CPU selection scheme.

27. The multi-processor system of claim 26, wherein, in response to determining the target CPU to accept the cache data transfer request, the target CPU is further configured to:
receive the cache data for the cache entry over the shared communications bus from the master CPU; and
store the received cache data in the cache entry in the local, shared cache memory of the target CPU.

28. The multi-processor system of claim 27, wherein the target CPU is further configured to:
in response to determining the willingness of the target CPU to accept the cache data transfer request, assign a buffer entry for the cache data transfer request; and
in response to determining the target CPU will not accept the cache data transfer request, release the buffer entry for the cache entry.

29. The multi-processor system of claim 26, wherein, in response to at least one of the observed one or more cache data transfer snoop responses from the other target CPUs indicating the willingness to accept the cache data transfer request, the target CPU is configured to determine acceptance of the cache data transfer request based on the predefined target CPU selection scheme comprising selection of the target CPU closest to the master CPU willing to accept the cache data transfer request based on the observed one or more cache data transfer snoop responses.

30. The multi-processor system of claim 29, wherein the target CPU is configured to determine the target CPU closest to the master CPU willing to accept the cache data transfer request based on a pre-configured CPU position table.

31. The multi-processor system of claim 30, wherein, in response to none of the observed one or more cache data transfer snoop responses from the other target CPUs indicating the willingness to accept the cache data transfer request, the target CPU is configured to accept the cache data transfer request based on the predefined target CPU selection scheme comprising selection of an only target CPU willing to accept the cache data transfer request.

32. The multi-processor system of claim 1, wherein the master CPU is further configured to determine a cache state of the cache entry in its associated respective local, shared cache memory; and
the master CPU is configured to:
issue the cache transfer request comprising a cache state/data transfer request for the cache entry comprising the cache state for the cache entry in a shared cache state in its associated respective local, shared cache memory on the shared communications bus to be snooped by the one or more target CPUs;
observe the one or more cache transfer snoop responses comprising one or more cache state/data transfer snoop responses from the one or more target CPUs in response to issuance of the cache state/data transfer request, each of the one or more cache state/data transfer snoop responses indicating a respective target CPU's willingness to accept the cache state/data transfer request; and
determine if at least one target CPU among the one or more target CPUs indicated a willingness to accept the cache state/data transfer request based on the observed one or more cache state/data transfer snoop responses.

33. The multi-processor system of claim 32, wherein the master CPU is configured to, in response to determining the at least one target CPU among the one or more target CPUs indicated the willingness to accept the cache state/data transfer request:
determine if the observed one or more cache state/data transfer snoop responses indicate the cache data for the cache entry is valid in the local, shared cache memory of the at least one target CPU; and
in response to determining that the cache data for the cache entry is valid in the local, shared cache memory of the at least one target CPU, update the cache state for the cache entry in the associated respective local, shared cache memory of the master CPU.

34. The multi-processor system of claim 33, wherein the master CPU is configured to, in response to determining that the cache data for the cache entry is not valid in the local, shared cache memory of the at least one target CPU:
determine a selected target CPU among the at least one target CPU for accepting the cache state/data transfer request based on the observed one or more cache state/data transfer snoop responses from other target CPUs and a predefined target CPU selection scheme; and
issue a cache data transfer comprising the cache data for the cache entry on the shared communications bus to the selected target CPU.

35. The multi-processor system of claim 32, wherein, in response to determining that no target CPUs among the one or more target CPUs indicated a willingness to accept the cache state/data transfer request, the master CPU is further configured to:
determine if the cache data for the cache entry is dirty; and
in response to the cache data for the cache entry being dirty, write back the cache data over the shared communications bus to a memory controller communicatively coupled to the shared communications bus, the memory controller configured to access a higher level memory.

36. The multi-processor system of claim 32, wherein, in response to the cache data for the cache entry being dirty, the master CPU is further configured to:
determine if a memory controller communicatively coupled to the shared communications bus indicated a willingness to accept the cache state/data transfer request; and
write back the cache data over the shared communications bus to the memory controller if the memory controller indicated the willingness to accept the cache state/data transfer request.

37. The multi-processor system of claim 35, wherein, in response to determining that the cache data for the cache entry is not dirty, the master CPU is configured to discontinue the cache state/data transfer request.

38. The multi-processor system of claim 32, wherein a target CPU among the one or more target CPUs is configured to:
receive the cache state/data transfer request on the shared communications bus from the master CPU;
determine a willingness to accept the cache state/data transfer request; and
issue a cache state/data transfer snoop response on the shared communications bus to be observed by the master CPU indicating the willingness of the target CPU to accept the cache state/data transfer request.

39. The multi-processor system of claim 38, wherein the target CPU is further configured to:
determine if its local, shared cache memory contains a copy of the cache entry for the received cache state/data transfer request;
in response to determining that the local, shared cache memory contains the copy of the cache entry for the received cache state/data transfer request, determine if the cache data for the cache entry in the local, shared cache memory of the target CPU is valid; and
in response to determining the cache data for the cache entry in the local, shared cache memory of the target CPU is valid:
observe the one or more cache state/data transfer snoop responses from other target CPUs among the one or more target CPUs in response to issuance of the cache state/data transfer request by the master CPU;
determine if the target CPU will accept the cache state/data transfer request based on the observed one or more cache state/data transfer snoop responses from the other target CPUs and a predefined target CPU selection scheme; and
in response to the target CPU determining that it will accept the cache state/data transfer request, update the cache state of the cache data for the cache entry of the local, shared cache memory of the target CPU.

40. The multi-processor system of claim 39, wherein the target CPU is further configured to, in response to the target CPU determining it is to not accept the cache state/data transfer request, discontinue the cache state/data transfer request.

41. The multi-processor system of claim 39, wherein, in response to determining that the local, shared cache memory does not contain the copy of the cache entry for the received cache state/data transfer request, the target CPU is further configured to:
observe the one or more cache state/data transfer snoop responses from the other target CPUs among the one or more target CPUs in response to issuance of the cache state/data transfer request by the master CPU;
determine if the target CPU will accept the cache state/data transfer request based on the observed one or more cache state/data transfer snoop responses from the other target CPUs and the predefined target CPU selection scheme; and
in response to the target CPU determining that it will accept the cache state/data transfer request:
update the cache state of the cache data for the cache entry of the local, shared cache memory of the target CPU;
receive the cache data for the cache entry over the shared communications bus from the master CPU; and
store the received cache data in the cache entry in the local, shared cache memory of the target CPU.

42. The multi-processor system of claim 41, wherein, in response to the target CPU determining that it will not accept the cache state/data transfer request, discontinue the cache state/data transfer request.

43. The multi-processor system of claim 32, further comprising a memory controller communicatively coupled to the shared communications bus, the memory controller configured to access a higher level memory, the memory controller configured to:
determine if the cache data for the cache state/data transfer request is dirty; and
in response to determining that the cache data for the cache state/data transfer request is dirty:
issue a cache state/data transfer snoop response on the shared communications bus to be observed by the master CPU indicating a willingness of the memory controller to accept the cache state/data transfer request;
observe the one or more cache state/data transfer snoop responses from the one or more target CPUs in response to issuance of the cache state/data transfer request by the master CPU;
determine if the memory controller will accept the cache state/data transfer request based on the observed one or more cache state/data transfer snoop responses from other target CPUs and a predefined target CPU selection scheme; and
in response to determining that the memory controller will accept the cache state/data transfer request:
receive the cache data for the cache entry over the shared communications bus from the master CPU; and
store the received cache data in the cache entry in the higher level memory.

44. The multi-processor system of claim 1, wherein each CPU among the plurality of CPUs further comprises a local, private cache memory configured to store cache data;
each CPU configured to access its associated respective local, shared cache memory in response to a cache miss for a memory access request to its respective local, private cache memory for the memory access request.

45. The multi-processor system of claim 1, wherein each CPU among the plurality of CPUs is further configured to:
access the cache entry in its associated respective local, shared cache memory in response to a memory access request; and
in response to a cache miss to the cache entry in its associated respective local, shared cache memory for the memory access request, issue the cache transfer request.

46. The multi-processor system of claim 1 integrated into a system-on-a-chip (SoC).

47. The multi-processor system of claim 1 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

48. The multi-processor system of claim 1, wherein each CPU among the plurality of CPUs is associated with a respective local, shared cache memory configured to store cache data.

49. The multi-processor system of claim 1, wherein at least one other first CPU among the plurality of CPUs is associated with the local, shared cache memory associated with a first CPU of the at least two CPUs, and at least one other second CPU among the plurality of CPUs is associated with the local, shared cache memory associated with a second CPU of the at least two CPUs.

50. A multi-processor system, comprising:
a means for sharing communications;
a plurality of means for processing data communicatively coupled to the means for sharing communications, wherein at least two means for processing data among the plurality of means for processing data are each associated with a local, shared means for storing cache data; and
a means for processing data among the plurality of means for processing data, comprising:
means for issuing a cache transfer request for a cache entry in its associated respective local, shared means for storing cache data, on a shared communications bus to be snooped by one or more target means for processing data among the plurality of means for processing data;
means for observing one or more cache transfer snoop responses from the one or more target means for processing data in response to the means for issuing the cache transfer request, each of the means for observing the one or more cache transfer snoop responses indicating a respective target means for processing data's willingness to accept the means for issuing the cache transfer request; and
means for determining if at least one target means for processing data among the one or more target means for processing data indicated a willingness to accept the means for issuing the cache transfer request based on the means for observing the one or more of cache transfer snoop responses.

51. The multi-processor system of claim 50, wherein a target means for processing data among the one or more target means for processing data comprises:
means for observing the means for issuing the cache transfer request on the means for sharing communications from the means for processing data;
means for determining the willingness to accept the means for issuing the cache transfer request; and
means for issuing a cache transfer snoop response on the means for sharing communications to be observed by the means for processing data indicating the willingness to accept the means for issuing the cache transfer request.

52. A method for performing cache transfers between local, shared cache memories in a multi-processor system, comprising:
issuing a cache transfer request for a cache entry in an associated respective local, shared cache memory associated with a master central processing unit (CPU) among a plurality of CPUs communicatively coupled to a shared communications bus, on the shared communications bus to be snooped by one or more target CPUs among the plurality of CPUs;
observing one or more cache transfer snoop responses from the one or more target CPUs in response to issuance of the cache transfer request, each of the one or more cache transfer snoop responses indicating a respective target CPU's willingness to accept the cache transfer request; and
determining if at least one target CPU among the one or more target CPUs indicated a willingness to accept the cache transfer request based on the observed one or more cache transfer snoop responses.

53. The method of claim 52, wherein, in response to none of the observed one or more cache transfer snoop responses indicating a willingness of a target CPU to accept the cache transfer request, further comprising issuing the cache transfer request for the cache entry from the master CPU to a memory controller communicatively coupled to the shared communications bus.

54. The method of claim 52, further comprising a target CPU among the one or more target CPUs:
receiving the cache transfer request on the shared communications bus from the master CPU;
determining a willingness to accept the cache transfer request;
issuing a cache transfer snoop response of the one or more cache transfer snoop responses on the shared communications bus to be observed by the master CPU indicating the willingness of the target CPU to accept the cache transfer request;
observing the one or more cache transfer snoop responses from other target CPUs among the one or more target CPUs indicating a willingness to accept the cache transfer request in response to issuance of the cache transfer request by the master CPU; and
determining acceptance of the cache transfer request based on the received one or more cache transfer snoop responses from the other target CPUs and a predefined target CPU selection scheme.

55. The method of claim 52, further comprising the master CPU determining a cache state of the cache entry in the associated respective local, shared cache memory; and
in response to the cache state of the cache entry being a shared cache state, further comprising the master CPU:
issuing the cache transfer request comprising a cache state transfer request for the cache entry in the shared cache state in its associated respective local, shared cache memory on the shared communications bus to be snooped by the one or more target CPUs;
observing the one or more cache transfer snoop responses comprising one or more cache state transfer snoop responses from the one or more target CPUs in response to issuance of the cache state transfer request, each of the one or more cache state transfer snoop responses indicating a respective target CPU's willingness to accept the cache state transfer request; and
determining if at least one target CPU among the one or more target CPUs indicated a willingness to accept the cache state transfer request based on the observed one or more cache state transfer snoop responses.

56. The method of claim 55, further comprising the master CPU updating the cache state for the cache entry in the associated respective local, shared cache memory in response to determining the at least one target CPU among the one or more target CPUs indicated the willingness to accept the cache state transfer request.

57. The method of claim 55, further comprising the master CPU determining that no target CPUs among the one or more target CPUs indicated a willingness to accept the cache state transfer request; and
in response to determining that no target CPUs among the one or more target CPUs indicated the willingness to accept the cache state transfer request, further comprising the master CPU:
issuing a next cache state transfer request for the cache entry in the shared cache state in its associated respective local, shared cache memory on the shared communications bus to be snooped by the one or more target CPUs;
observing one or more next cache state transfer snoop responses from the one or more target CPUs among the plurality of CPUs in response to issuance of the next cache state transfer request, each of the one or more next cache state transfer snoop responses indicating a respective target CPU's willingness to accept the next cache state transfer request; and
determining if the at least one target CPU among the one or more target CPUs indicated the willingness to accept the next cache state transfer request based on the observed one or more next cache state transfer snoop responses.

58. The method of claim 55, further comprising the master CPU determining that no target CPUs among the one or more target CPUs indicated a willingness to accept the cache state transfer request, and
in response to determining that no target CPUs among the one or more target CPUs indicated the willingness to accept the cache state transfer request, further comprising the master CPU:
issuing the cache transfer request comprising a cache data transfer request for the cache entry in the shared cache state in its associated respective local, shared cache memory on the shared communications bus to be snooped by the one or more target CPUs;
observing the one or more cache transfer snoop responses comprising one or more cache data transfer snoop responses from the one or more target CPUs in response to issuance of the cache data transfer request, each of the one or more cache data transfer snoop responses indicating a respective target CPU's willingness to accept the cache data transfer request; and
determining if at least one target CPU among the one or more target CPUs indicated a willingness to accept the cache data transfer request based on the observed one or more cache data transfer snoop responses.

59. The method of claim 55, further comprising a target CPU among the one or more target CPUs:
receiving the cache state transfer request on the shared communications bus from the master CPU;
determining a willingness to accept the cache state transfer request;
issuing a cache state transfer snoop response on the shared communications bus to be observed by the master CPU indicating the willingness of the target CPU to accept the cache state transfer request;
observing the one or more cache state transfer snoop responses from other target CPUs among the one or more target CPUs in response to issuance of the cache state transfer request by the master CPU; and
determining acceptance of the cache state transfer request based on the observed one or more cache state transfer snoop responses from the other target CPUs and a predefined target CPU selection scheme.

60. The method of claim 59, further comprising the target CPU:
determining that none of the observed one or more cache state transfer snoop responses from the other target CPUs indicating a willingness to accept the cache state transfer request; and
accepting the cache state transfer request based on the predefined target CPU selection scheme comprising selection of an only target CPU willing to accept the cache state transfer request in response to determining that none of the observed one or more cache state transfer snoop responses from the other target CPUs indicating the willingness to accept the cache state transfer request.

61. The method of claim 52, further comprising the master CPU determining a cache state of the cache entry in its associated respective local, shared cache memory; and
in response to the cache state of the cache entry being an exclusive cache state: comprising the master CPU:
issuing the cache transfer request comprising a cache data transfer request for the cache entry in a shared cache state in its associated respective local, shared cache memory on the shared communications bus to be snooped by the one or more target CPUs;
observing the one or more cache transfer snoop responses comprising one or more cache data transfer snoop responses from the one or more target CPUs in response to issuance of the cache data transfer request, each of the one or more cache data transfer snoop responses indicating a respective target CPU's willingness to accept the cache data transfer request; and
determining if at least one target CPU among the one or more target CPUs indicated a willingness to accept the cache data transfer request based on the observed one or more cache data transfer snoop responses.

62. The method of claim 61, comprising the master CPU, in response to determining the at least one target CPU among the one or more target CPUs indicated the willingness to accept the cache data transfer request:
determining a selected target CPU among the at least one target CPU for accepting the cache data transfer request based on the observed one or more cache data transfer snoop responses from other target CPUs and a predefined target CPU selection scheme; and
issuing a cache data transfer comprising the cache data for the cache entry on the shared communications bus to the selected target CPU.

63. The method of claim 55, further comprising a target CPU among the one or more target CPUs:
receiving the cache data transfer request on the shared communications bus from the master CPU;
determining a willingness to accept the cache data transfer request;
issuing a cache data transfer snoop response on the shared communications bus to be observed by the master CPU indicating the willingness of the target CPU to accept the cache data transfer request;
observing the one or more cache data transfer snoop responses from other target CPUs among the one or more target CPUs indicating a willingness to accept the cache data transfer request in response to issuance of the cache data transfer request by the master CPU; and
determining if the target CPU will accept the cache data transfer request based on the observed one or more cache data transfer snoop responses from the other target CPUs and a predefined target CPU selection scheme.

64. The method of claim 63, wherein, in response to determining the target CPU to accept the cache data transfer request, further comprising the target CPU:
receiving the cache data for the cache entry over the shared communications bus from the master CPU; and
storing the received cache data in the cache entry in the local, shared cache memory of the target CPU.

65. The method of claim 52, further comprising the master CPU determining a cache state of the cache entry in its associated respective local, shared cache memory; and
comprising the master CPU:
issuing the cache transfer request comprising a cache state/data transfer request for the cache entry comprising the cache state for the cache entry in a shared cache state in its associated respective local, shared cache memory on the shared communications bus to be snooped by the one or more target CPUs;
observing the one or more cache transfer snoop responses comprising one or more cache state/data transfer snoop responses from the one or more target CPUs in response to issuance of the cache state/data transfer request, each of the one or more cache state/data transfer snoop responses indicating a respective target CPU's willingness to accept the cache state/data transfer request; and
determining if at least one target CPU among the one or more target CPUs indicated a willingness to accept the cache state/data transfer request based on the observed one or more cache data transfer snoop responses.

66. The method of claim 65, comprising the master CPU, in response to determining the at least one target CPU among the one or more target CPUs indicated the willingness to accept the cache state/data transfer request:
determining if the observed one or more cache data transfer snoop responses indicate cache data for the cache entry is valid in the local, shared cache memory of the at least one target CPU; and
updating the cache state for the cache entry in the associated respective local, shared cache memory of the master CPU in response to determining that the cache data for the cache entry is valid in the local, shared cache memory of the at least one target CPU.

67. The method of claim 66, further comprising the master CPU:
determining that the cache data for the cache entry is not valid in the local, shared cache memory of the at least one target CPU; and
in response to determining that the cache data for the cache entry is not valid in the local, shared cache memory of the at least one target CPU:
determining a selected target CPU among the at least one target CPU for accepting the cache state/data transfer request based on the observed one or more cache state/data transfer snoop responses from other target CPUs and a predefined target CPU selection scheme; and
issuing a cache data transfer comprising the cache data for the cache entry on the shared communications bus to the selected target CPU.

68. The method of claim 65, further comprising the master CPU:
determining that no target CPUs among the one or more target CPUs indicated a willingness to accept the cache data transfer request;
in response to determining that no target CPUs among the one or more target CPUs indicated the willingness to accept the cache data transfer request, determining if cache data for the cache entry is dirty; and
in response to determining that the cache data for the cache entry is dirty, write back the cache data over the shared communications bus to a memory controller communicatively coupled to the shared communications bus, the memory controller configured to access a higher level memory.

69. The method of claim 65, wherein, in response to determining that the cache data for the cache entry is dirty, further comprising the master CPU:
determining if a memory controller communicatively coupled to the shared communications bus indicated a willingness to accept the cache state/data transfer request; and
further comprising the master CPU writing back the cache data over the shared communications bus to the memory controller if the memory controller indicated the willingness to accept the cache state/data transfer request.

70. The method of claim 65, comprising a target CPU among the one or more target CPUs:
receiving the cache state/data transfer request on the shared communications bus from the master CPU;
determining a willingness to accept the cache state/data transfer request; and
issuing a cache state/data transfer snoop response on the shared communications bus to be observed by the master CPU indicating the willingness of the target CPU to accept the cache state/data transfer request.

71. The method of claim 70, further comprising the target CPU:
determining if its local, shared cache memory contains a copy of the cache entry for the received cache state/data transfer request;
in response to determining that the local, shared cache memory contains the copy of the cache entry for the received cache state/data transfer request, determining if the cache data for the cache entry is in the local, shared cache memory of the target CPU is valid; and
in response to determining cache data for the cache entry in the local, shared cache memory of the target CPU is valid, further comprising the target CPU:
observing the one or more cache state/data transfer snoop responses from other target CPUs among the one or more target CPUs in response to issuance of the cache state/data transfer request by the master CPU;
determining if the target CPU will accept the cache state/data transfer request based on the observed one or more cache state/data transfer snoop responses from the other target CPUs and a predefined target CPU selection scheme; and
in response to the target CPU determining that it will accept the cache state/data transfer request, updating the cache state of the cache data for the cache entry of the local, shared cache memory of the target CPU.

72. The method of claim 71, wherein, in response to determining that the local, shared cache memory does not contain the copy of the cache entry for the received cache state/data transfer request, further comprising the target CPU:
observing the one or more cache state/data transfer snoop responses from the other target CPUs among the one or more target CPUs in response to issuance of the cache state/data transfer request by the master CPU;
determining if the target CPU will accept the cache state/data transfer request based on the observed one or more cache state/data transfer snoop responses from the other target CPUs and the predefined target CPU selection scheme; and
in response to the target CPU determining that it will accept the cache state/data transfer request, further comprising the target CPU:
updating the cache state of the cache data for the cache entry of the local, shared cache memory of the target CPU;
receiving the cache data for the cache entry over the shared communications bus from the master CPU; and
storing the received cache data in a cache entry in the local, shared cache memory of the target CPU.

73. The method of claim 65, further comprising a memory controller communicatively coupled to the shared communications bus:
determining if cache data for the cache state/data transfer request is dirty; and
in response to determining that the cache data for the cache state/data transfer request is dirty:
issuing a cache state/data transfer snoop response on the shared communications bus to be observed by the master CPU indicating a willingness of the memory controller to accept the cache state/data transfer request;
observing the one or more cache state/data transfer snoop responses from the one or more target CPUs in response to issuance of the cache state/data transfer request by the master CPU;
determining if the memory controller will accept the cache state/data transfer request based on the observed one or more cache state/data transfer snoop responses from other target CPUs and a predefined target CPU selection scheme; and
in response determining that the memory controller will accept the cache state/data transfer request:
receiving the cache data for the cache entry over the shared communications bus from the master CPU; and
storing the received cache data in the cache entry in a higher level memory.

74. The method of claim 52, wherein the local, shared cache memory is only associated with the master CPU.

75. The method of claim 52, wherein the local, shared cache memory is associated with at least one other CPU among the plurality of CPUs.
